(19) United States
(12) Patent Application Publication
(10) Pub. No.: US 2022/0317293 A1
(43) Pub. Date: Oct. 6, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: MIKIO NAKAI, TOKYO (JP); RYO WATANABE, TOKYO (JP)

(21) Appl. No.: 17/629,540

(22) PCT Filed: Jul. 8, 2020
(86) PCT No.: PCT/JP2020/026620

§ 371 Date: Jan. 24, 2022

(30) Foreign Application Priority Data
Aug. 5, 2019 (JP) 2019-143952

(51) Int. Cl. G01S 15/86; G01S 17/87; G01S 15/93; G01S 17/89; G01S 17/93

(52) U.S. Cl. CPC G01S 15/86; G01S 17/87; G01S 15/93; G01S 17/89; G01S 17/93

(57) ABSTRACT

An information processing apparatus according to the present disclosure includes: a preliminary map generation unit that creates a preliminary map based on ranging information obtained by an optical ranging sensor; an acquisition unit that acquires measurement information obtained by an ultrasonic sensor; and a difference extraction unit that extracts difference information between the preliminary map and the measurement information.

### FIELD

The present disclosure relates to an information processing apparatus, an information processing method, and an information processing program.

### BACKGROUND

There are known techniques of performing detection using a plurality of types of sensors. For example, there is provided a technique of detecting an obstacle by an ultrasonic sensor (first obstacle detector) and an optical sensor (second obstacle detector).

### CITATION LIST

### Patent Literature

Patent Literature 1: JP 2018-155597 A

### SUMMARY

### Technical Problem

According to the known technique, a detection result of one of the first obstacle detector or the second obstacle detector having different detection processes is used as a basis for changing the detection condition of the other obstacle detector.

However, the known technique is not necessarily capable of extracting a difference between information detected by a plurality of types of sensors. For example, in the known technique, only one detection result is used as a basis for changing the other detection condition, making it difficult to collect information reflecting detection results of the plurality of types of sensors. In addition, since the known technique is simply intended to detect the presence or absence of an obstacle, it is possible to achieve the purpose by using one detection result as a basis for changing the other detection condition as described above. However, it is not possible to perform, as in map creation, processes of specifying an undetectable range and then appropriately correcting the range for actual situations. That is, there is a problem that it is not possible to generate a map in consideration of information regarding a plurality of types of sensors.

In view of this, the present disclosure proposes an information processing apparatus, an information processing method, and an information processing program capable of extracting a difference between information detected by a plurality of types of sensors.

### Solution to Problem

According to the present disclosure, an information processing apparatus includes a preliminary map generation unit that creates a preliminary map based on ranging information obtained by an optical ranging sensor; an acquisition unit that acquires measurement information obtained by an ultrasonic sensor; and a difference extraction unit that extracts difference information between the preliminary map and the measurement information.

### BRIEF DESCRIPTION OF DRAWINGS

FIG. 1 is a diagram illustrating an example of information processing according to an embodiment of the present disclosure.

FIG. 2 is a diagram illustrating an example of information processing according to an embodiment of the present disclosure.

FIG. 3 is a diagram illustrating a configuration example of an information processing system according to an embodiment.

FIG. 4 is a diagram illustrating a configuration example of an information processing apparatus according to an embodiment.

FIG. 5 is a diagram illustrating a configuration example of a mobile device according to an embodiment.

FIG. 6 is a flowchart illustrating a procedure of information processing according to an embodiment.

FIG. 7 is a flowchart illustrating a procedure of information processing according to an embodiment.

FIG. 8 is a flowchart illustrating a map adjustment procedure according to an embodiment.

FIG. 9 is a diagram illustrating an example of movement of a mobile device according to an embodiment.

FIG. 10 is a diagram illustrating an example of movement of a mobile device according to an embodiment.

FIG. 11 is a diagram illustrating an example of detection by an optical ranging sensor according to an embodiment.

FIG. 12 is a diagram illustrating an example of detection by an optical ranging sensor according to an embodiment.

FIG. 13 is a diagram illustrating an example of map adjustment according to an embodiment.

FIG. 14 is a diagram illustrating an example of a display according to an embodiment.

FIG. 15 is a diagram illustrating an example of automatic adjustment of a map.

FIG. 16 is a diagram illustrating an example of a conceptual diagram of a configuration of an information processing system according to a modification.

FIG. 17 is a hardware configuration diagram illustrating an example of a computer that actualizes functions of a mobile device and an information processing apparatus.

### DESCRIPTION OF EMBODIMENTS

Embodiments of the present disclosure will be described below in detail with reference to the drawings. Note that the information processing apparatus, the information processing method, and the information processing program according to the present application are not limited by the embodiments. Moreover, in each of the following embodiments, the same parts are denoted by the same reference symbols, and a repetitive description thereof will be omitted.

The present disclosure will be described in the following order.

1. Embodiments

1-1. Overview of information processing according to embodiment of present disclosure

1-2. Configuration of information processing system according to embodiment

1-3. Configuration of information processing apparatus according to embodiment

1-4. Configuration of mobile device according to embodiment

1-5. Procedure of information processing according to embodiment

1-6. Procedure of adjusting map according to embodiment

1-7. Movement and detection of mobile body

1-7-1. Movement of mobile body

1-7-2. Detection by optical ranging sensor

1-8. Application examples

1-8-1. Automatic arrangement

1-8-2. Image display

1-9. Automatic adjustment of map

2. Other embodiments

2-1. Other configuration examples

2-2. Conceptual diagram of configuration of information processing system

2-3. Others

3. Effects according to present disclosure

4. Hardware configuration

### 1. Embodiments

### 1-1. Overview of Information Processing According to Embodiment of Present Disclosure

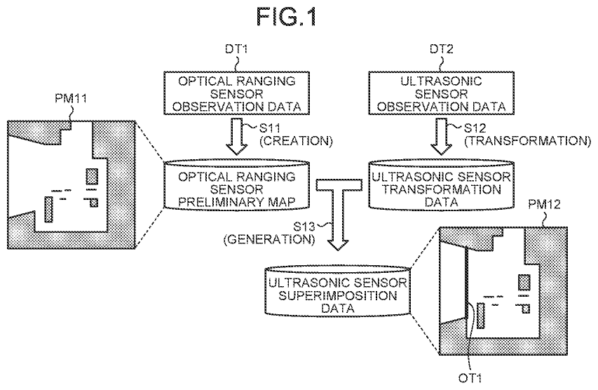

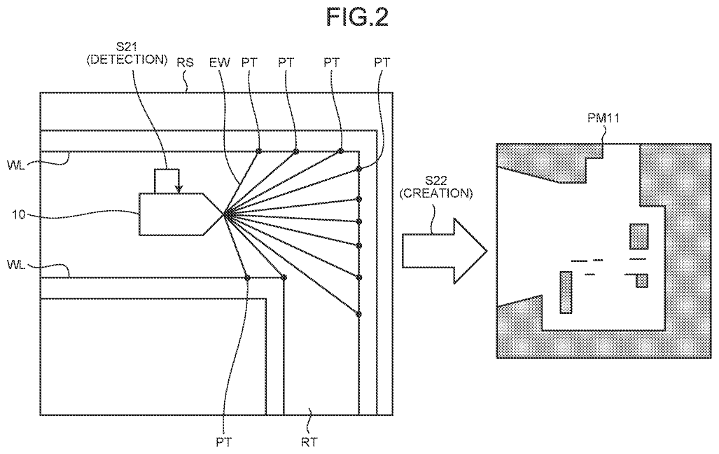

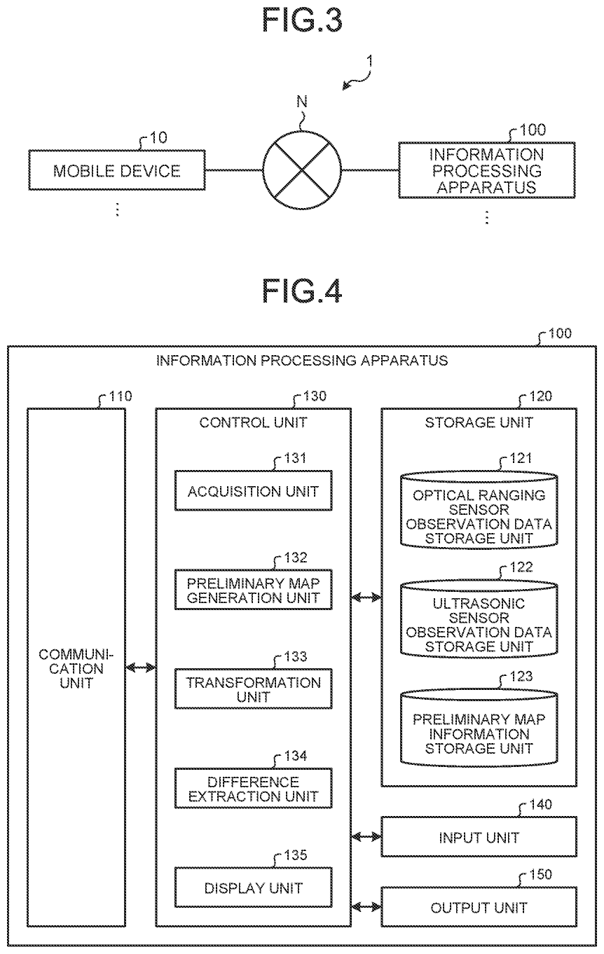

FIGS. 1 and 2 are diagrams illustrating an example of information processing according to an embodiment of the present disclosure. The information processing according to the embodiment of the present disclosure is implemented by an information processing system 1 (refer to FIG. 3) including a mobile device 10 and an information processing apparatus 100 (refer to FIG. 3) illustrated in FIG. 2.

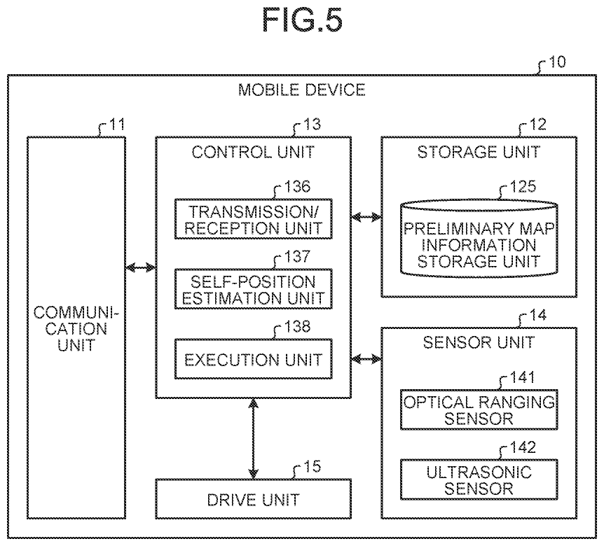

The mobile device 10 and the information processing apparatus 100 included in the information processing system 1 execute information processing according to the embodiment. The mobile device 10 includes an optical ranging sensor 141 (refer to FIG. 5) and an ultrasonic sensor 142 (refer to FIG. 5), and collects information detected by each of the sensors. In this manner, the mobile device 10 collects information detected by a plurality of types of sensors. Hereinafter, information detected by the optical ranging sensor 141 is referred to as ranging information, while information detected by the ultrasonic sensor 142 is referred to as measurement information. The information processing system 1 creates a preliminary map based on ranging information obtained by the optical ranging sensor 141. The processes other than the detection by the sensor in the processes illustrated in FIGS. 1 and 2 may be performed by either the mobile device 10 or the information processing apparatus 100 of the information processing system 1. Furthermore, the mobile device 10 performs self-position estimation based on the preliminary map. The preliminary map referred to herein is, for example, a map corresponding to a place (space) where the mobile device 10 performs autonomous travel after the processes illustrated in FIGS. 1 and 2.

In the examples of FIGS. 1 and 2, an autonomous mobile robot is illustrated as an example of the mobile device 10. Note that the mobile device 10 may be various mobile bodies such as an automobile that travels by automated driving, and this point will be described below. The examples of FIGS. 1 and 2 illustrate a case where Light Detection and Ranging, Laser Imaging Detection and Ranging (LiDAR) is used as an example of the optical ranging sensor 141. Note that the optical ranging sensor 141 is not limited to LiDAR, and may be various sensors such as a time of flight (ToF) sensor and a stereo camera. Furthermore, the information processing apparatus 100 extracts difference information between the preliminary map and the measurement information.

In the example of FIG. 1, the information processing system 1 creates an optical ranging sensor preliminary map using optical ranging sensor observation data DT1 (step S11). The information processing system 1 generates a preliminary map PM11 being an optical ranging sensor preliminary map by using the optical ranging sensor observation data DT1. For example, the information processing system 1 generates the preliminary map PM11 using processes as illustrated in FIG. 2.

The mobile device 10 performs detection by the optical ranging sensor 141 being LiDAR (step S21). The mobile device 10 performs detection regarding the surrounding environment using the optical ranging sensor 141. Using the optical ranging sensor 141, the mobile device 10 performs detection regarding a route RT along which the mobile device 10 travels. In the example of FIG. 2, the mobile device 10 uses the optical ranging sensor 141 to detect a wall WL and the like located around the route RT. As illustrated in a schematic diagram RS in FIG. 2, the mobile device 10 collects information regarding the walls WL in the surroundings and the like by an electromagnetic wave EW detected by the optical ranging sensor 141. Using the detection of the optical ranging sensor 141, the mobile device 10 collects a point cloud (point cloud information) such as a plurality of points PT in FIG. 2. The mobile device 10 collects the point cloud information while traveling. After the processes illustrated in FIGS. 1 and 2, the mobile device 10 collects point cloud information using the detection of the optical ranging sensor 141 while traveling in the place of autonomous travel of the mobile device 10.

Subsequently, the information processing system 1 creates a preliminary map (step S22). The information processing apparatus 100 creates a preliminary map. Note that the mobile device 10 may create the preliminary map. The information processing system 1 generates a preliminary map of the optical ranging sensor 141 while controlling a robot such as the mobile device 10 to travel. In the example of FIG. 2, the information processing system 1 creates the preliminary map PM11 using point cloud information. For example, the information processing system 1 generates the preliminary map using a point cloud by LiDAR or the like by appropriately using various technologies. The information processing system 1 generates the preliminary map PM11 using a map creation technology using a point cloud by LiDAR or the like. In this manner, the information processing system 1 collects point cloud information while traveling, and creates the preliminary map of the real world. For example, the information processing system 1 may create the preliminary map PM11 using information acquired from the mobile device 10, or the mobile device 10 may create the preliminary map PM11. A white portion on the map such as the preliminary map PM11 indicates an area (region) in which no object has not been detected, a black portion on the map such as the preliminary map PM11 indicates an area (region) in which an object has been detected, and a gray portion on the map such as the preliminary map PM11 indicates an area (region) in which no detection has been performed. For example, the white portion in the map such as the preliminary map PM11 indicates a passage where an object is observed, the black portion in the map such as the preliminary map PM11 indicates a wall observed by a point cloud, and the gray portion in the map such as the preliminary map PM11 indicates a region in which no observation has been performed. That is, the white portion in the map such as the preliminary map PM11 indicates an area (region) where the mobile body 10 can travel, while the black portion and the gray portion in the map such as the preliminary map PM11 indicate areas (regions) where the mobile body 10 cannot travel.

Furthermore, in the example of FIG. 1, the information processing system 1 transforms ultrasonic sensor observation data DT2 (step S12). The ultrasonic sensor observation data DT2 is measurement information detected by the ultrasonic sensor 142 at the same time as creation of the preliminary map PM11. The same time as creation of the preliminary map PM11 may be, for example, a timing at which the optical ranging sensor 141 detects data used in creating the preliminary map PM11. For example, the data is measurement information detected by the ultrasonic sensor 142 when the mobile device 10 performs detection by using the optical ranging sensor 141 to create the preliminary map PM11. The ultrasonic sensor observation data DT2 is data containing information corresponding to a measurement object OT1. The object corresponding to the measurement object OT1 is assumed to be a transmissive object such as glass, or a reflecting object such as a mirror, which cannot be correctly detected by the optical ranging sensor 141. The ultrasonic sensor observation data DT2 is data detected by the ultrasonic sensor 142 and subjected to frame-by-frame processing.

Here, a coordinate system of data observed (detected) by the optical ranging sensor 141 is different from a coordinate system of data observed (detected) by the ultrasonic sensor 142. Therefore, the information processing system 1 needs to unify the coordinate system by coordinate transformation. Accordingly, the information processing system 1 unifies the coordinate system by superimposing a result of observation performed by the ultrasonic sensor 142 on the coordinate system (Lidar preliminary map coordinate system) of the optical ranging sensor 141 by using the relative position from the own device, or the like. For example, the information processing system 1 transforms the observation result of the ultrasonic sensor 142 into the coordinate system of the optical ranging sensor 141 and holds the observation result. In the example of FIG. 1, the information processing apparatus 100 performs transformation of the ultrasonic sensor observation data DT2. Note that the mobile device 10 may transform the ultrasonic sensor observation data DT2. The information processing system 1 transforms a coordinate system (coordinate system SX) corresponding to the measurement information detected by the ultrasonic sensor 142 into a coordinate system (coordinate system SY) of the optical ranging sensor 141. The information processing system 1 performs a process of transforming the coordinate system SX of the ultrasonic sensor 142 into the coordinate system SY of the optical ranging sensor 141. The information processing system 1 transforms the ultrasonic sensor observation data DT2 by appropriately using various known techniques related to coordinate transformation. The information processing system 1 may transform the ultrasonic sensor observation data DT2 by appropriately using a technique such as geometric transformation such as rotation, translation, or scaling, or affine transformation. With this operation, the information processing system 1 generates ultrasonic sensor transformation data in which the coordinate system of the ultrasonic sensor observation data DT2 has been transformed. The information processing system 1 generates ultrasonic sensor transformation data obtained by transforming the coordinate system SX of the ultrasonic sensor observation data DT2 into the coordinate system SY. In this manner, the information processing system 1 holds the observation result by the ultrasonic sensor 142 in a state of being transformed into the coordinate system of the optical ranging sensor 141 such as LiDAR.

In addition, the information processing system 1 extracts difference information between the optical ranging sensor preliminary map and the ultrasonic sensor transformation data. For example, the information processing system 1 extracts, as difference information, a position where no obstacle is present in the optical ranging sensor preliminary map and where an obstacle is present in the ultrasonic sensor transformation data. In the example of FIG. 1, the information processing system 1 extracts, as difference information, a position (region) corresponding to the measurement object OT1 on which no obstacle is observed in the optical ranging sensor preliminary map and on which an obstacle is observed in the ultrasonic sensor transformation data. The measurement object OT1 corresponds to a wall observed by the ultrasonic sensor. This difference represents a transmissive object for the optical ranging sensor, such as glass. Conversely, there can be a difference that no obstacle is present in the ultrasonic sensor transformation data while an obstacle is present in the optical ranging sensor preliminary map. This is due to a reflecting object for an optical ranging sensor, such as a mirror, and represents a virtual image due to reflection. Since it is not a real object, it is an obstacle to be removed from the difference information.

Subsequently, the information processing system 1 generates ultrasonic sensor superimposition data (step S13). The information processing system 1 generates ultrasonic sensor superimposition data based on the preliminary map PM11 being an optical ranging sensor preliminary map and based on the ultrasonic sensor transformation data. By arranging the measurement object OT1 indicated by the ultrasonic sensor transformation data on the preliminary map PM11, the information processing system 1 generates ultrasonic sensor superimposition data. The information processing system 1 generates the ultrasonic sensor superimposition data by arranging the measurement object OT1 at the position indicated by the ultrasonic sensor transformation data in the preliminary map PM11. The information processing system 1 generates a preliminary map PM12 in which the measurement object OT1 is arranged on the preliminary map PM11. Note that the information processing system 1 may extract the difference information using the preliminary map PM11 and the preliminary map PM12. The information processing system 1 may compare the preliminary map PM11 with the preliminary map PM12 and extract different positions (regions) as difference information. In this case, the information processing system 1 compares the preliminary map PM11 with the preliminary map PM12, and extracts a position (region) corresponding to the measurement object OT1 as the difference information.

Details of deletion processing on the measurement object OT1 from the preliminary map and arrangement processing of obstacles, each performed after arrangement of the measurement object OT1 as described above, will be described below.

As described above, the information processing system 1 can extract a difference between the optical ranging sensor preliminary map based on the ranging information obtained by the optical ranging sensor 141 and the measurement information obtained by the ultrasonic sensor 142. Accordingly, the information processing system 1 can extract a difference in information detected by a plurality of types of sensors.

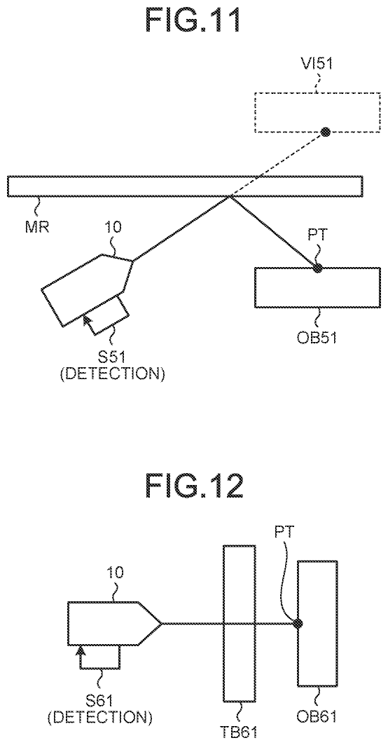

Here, there might be an obstacle (invisible wall) that cannot be detected by the optical ranging sensor 141 such as LiDAR used for calculating the self-position of the robot and detecting the obstacle, and this might adversely affect the self-position estimation and the obstacle avoidance. Examples of the obstacle that cannot be detected by the optical ranging sensor 141 include a reflecting object such as a mirror or a stainless plate (SUS plate) that totally reflects the electromagnetic wave detected by the optical ranging sensor 141 as illustrated in FIG. 11. A reflecting object gives various views depending on the viewing angle and thus might not be able to produce an accurate preliminary map. This can lead to a failure in correct matching and thus, it is desirable to remove the point cloud from the preliminary map. In addition, these are also desired to be embedded as obstacles on the preliminary map. In addition, examples of obstacles that cannot be detected by the optical ranging sensor 141 include a transparent object such as an acrylic plate or glass that transmits an electromagnetic wave detected by the optical ranging sensor 141 as illustrated in FIG. 12. Since a transparent object is not sensed at all by an optical sensor such as the optical ranging sensor 141, it is difficult for the optical ranging sensor 141 to detect the transparent object as an obstacle. In the process of self-position estimation, there would be no problem since it is merely not used as a matching target. However, in a case where obstacle detection is performed by an optical sensor such as the optical ranging sensor 141, these are desired to be embedded as an obstacle on the preliminary map. In addition, there would be no problem if it is possible to conduct post-processing such as point cloud deletion and obstacle arrangement after the preliminary map creation. However, it would be difficult to accurately designate where and how to make adjustments on the map only with data of the optical ranging sensor 141 such as LiDAR.

As described above, in a place where the mobile body autonomously travels, there is an obstacle formed of a material such as a mirror or an acrylic plate which is not detected by, that is, invisible to the optical ranging sensor 141. In a case where autonomous traveling is performed only with self-position estimation using point cloud matching of the optical ranging sensor 141 or obstacle detection by the optical ranging sensor 141, there is a case where it is difficult to handle an obstacle such as a mirror or an acrylic plate. In view of this, the information processing system 1 performs adjustment of a preliminary map, designation of an entry prohibited area, and the like using a sensor (for example, the ultrasonic sensor 142) of a type other than the optical ranging sensor 141.

Specifically, an observation result by the ultrasonic sensor 142 is drawn as an auxiliary line on the preliminary map, or the preliminary map is adjusted on a tool. With this operation, the information processing system 1 can generate an appropriate map using a plurality of types of sensors.

The information processing system 1 uses the optical ranging sensor 141 together with the ultrasonic sensor 142, that is, by combining the ultrasonic sensor to the optical ranging sensor, it is possible to detect a wall that is not optically visible. Note that simply using the ultrasonic sensor at the same time as the optical ranging sensor causes the following problems. The ultrasonic sensor has a narrower detection range compared with an optical ranging sensor or the like. Therefore, it is necessary to dispose a plurality of ultrasonic sensors so as to surround the entire circumference of the robot. In addition, the ultrasonic sensor has lower detection accuracy (resolution) as compared with an optical ranging sensor or the like, making it difficult to perform self-position calculation. In addition, there is a case where the ultrasonic sensor cannot be used as obstacle detection depending on necessary calculation accuracy. In addition, by simply using the ultrasonic sensor simultaneously with the optical ranging sensor, it would not be possible to cancel the influence of the erroneous point cloud of the optical sensor due to the SUS plate or the like, leading to a failure in canceling the adverse effect on the self-position calculation. In addition, an increase in the number of sensors also increases the cost, power, processing load, and the like.

In view of these, at the time of creating the preliminary map, the information processing system 1 holds the measurement result obtained by the ultrasonic sensor 142 together with the result of the optical ranging sensor 141, and displays the measurement result as an auxiliary line on the preliminary map so as to enable a person to explicitly perform adjustment. Specifically, the information processing system 1 removes a place that is not desired to be used as a point cloud from the preliminary map, or embeds a wall or the like that is invisible to the optical ranging sensor 141 such as LiDAR as a prohibited region in the preliminary map.

In this manner, by acquiring data of the ultrasonic sensor 142 at the time of creating the preliminary map, the information processing system 1 can detect a wall invisible to the optical sensor by performing an operation of looking around at the time of creating the preliminary map without mounting a plurality of the ultrasonic sensors 142 on the mobile device 10. In addition, the information processing system 1 can remove a place not desired to be used as a point cloud for self-position calculation from the point cloud of the optical ranging sensor 142. With this configuration, the information processing system 1 does not need the ultrasonic sensor 142 at the time of operation after creation of the preliminary map. In this case, the mobile device 10 does not include the ultrasonic sensor 142. In addition, by explicitly performing adjustment by a person with the use of the auxiliary line by the ultrasonic sensor 142, the information processing system 1 can easily make a decision regarding the presence or absence of an obstacle that is difficult to be decided only by the optical sensor. Furthermore, the information processing system 1 enables a person to complement the result of the ultrasonic sensor 142 when having low accuracy.

By using the map generated as described above, the mobile body does not have to include the ultrasonic sensor 142. Therefore, at the time of autonomous traveling after map generation, a mobile body including only the optical ranging sensor 141 can move as desired. That is, by using a map generated with the use of a plurality of types of sensors as described above, self-position estimation and obstacle avoidance using only the optical ranging sensor 141 can be implemented in an environment including a material invisible to the optical ranging sensor 141. With this configuration, the information processing system 1 can suppress an increase in cost, enlargement of machine body, and the like due to the presence of sensors other than the optical ranging sensor.

In addition, for example, in a case where a place to travel is determined in advance in a system that performs self-position calculation by point cloud matching using an optical ranging sensor such as LiDAR or ToF, an observation result of the travel place is often held as a preliminary map. Although such a preliminary map has some distortion as compared with the real world, the mobile device 10 such as a robot basically operates with coordinates on a preliminary map, and thus, it would not lead to a big problem as long as the same coordinates can be always acquired at the same place. However, in a case where a map is updated by detections by a plurality of types of sensors, a problem might occur due to the reasons of different coordinate systems of the sensors, or the like. For example, in a case where the preliminary map created by the detection of the optical ranging sensor 141 is updated based on information detected by the ultrasonic sensor 142 having a coordinate system not the same as the coordinate system of the optical ranging sensor 141, there can be a case where the map is not appropriately updated. The information processing system 1 updates a map with unified coordinate systems, making it possible to appropriately update the map, leading to a solution of the above-described problem.

### 1-2. Configuration of Information Processing System According to Embodiment

The information processing system 1 illustrated in FIG. 3 will be described. FIG. 3 is a diagram illustrating a configuration example of an information processing system according to an embodiment. As illustrated in FIG. 3, the information processing system 1 includes the mobile device 10 and the information processing apparatus 100. The mobile device 10 and the information processing apparatus 100 are communicably connected to each other in a wired or wireless channel via a network N. Note that the information processing system 1 illustrated in FIG. 3 may include a plurality of the mobile devices 10 and a plurality of the information processing apparatuses 100.

The mobile device 10 creates a preliminary map corresponding to a travel route based on a ranging result of a ranging sensor, and performs self-position estimation based on the preliminary map. Although the example of FIG. 2 is a case where the mobile device 10 is an autonomous mobile robot, the mobile device 10 may be various mobile bodies such as a vehicle. That is, the mobile device 10 is not limited to the autonomous mobile robot as long as it can transmit/receive information to/from the information processing apparatus 100, and may be any device, for example, various mobile bodies such as an automobile and a drone that travel by automated driving. The mobile device 10 may be any device as long as it can implement the processes in the embodiment.

The mobile device 10 transmits information regarding the preliminary map to the information processing apparatus 100. The mobile device 10 transmits the created preliminary map to the information processing apparatus 100. With this operation, the information processing apparatus 100 acquires the preliminary map. Furthermore, the mobile device 10 may transmit sensor information detected by a sensor unit 14 to the information processing apparatus 100. In this case, the mobile device 10 transmits sensor information detected by a sensor such as the optical ranging sensor 141 to the information processing apparatus 100. The mobile device 10 transmits distance information between a measurement target measured by the optical ranging sensor 141 and the ranging sensor, to the information processing apparatus 100. With this operation, the information processing apparatus 100 acquires distance information between the measurement target measured by the optical ranging sensor 141 and the ranging sensor.

In addition, the mobile device 10 performs self-position estimation using the point cloud information detected at the time of actual traveling and the preliminary map. The mobile device 10 performs self-position calculation by matching the point cloud data such as LiDAR obtained at the time of actual traveling with the preliminary map. In the example of FIG. 1, the mobile device 10 detects the point cloud information while traveling in a place corresponding to the preliminary map PM11, and performs self-position estimation by matching the detected point cloud information with the preliminary map. Subsequently, the mobile device 10 transmits information indicating the estimated self-position to the information processing apparatus 100. The mobile device 10 transmits a result of the self-position estimation to the information processing apparatus 100.

The information processing apparatus 100 is an information processing apparatus used by a user. The information processing apparatus 100 may communicate with the mobile device 10 via the network N and give an instruction to control the mobile device 10 based on information collected by the mobile device 10 and various sensors. The information processing apparatus 100 may be any apparatus as long as it can implement the processes in the embodiment. The information processing apparatus 100 may be any apparatus as long as it has a configuration including a display (output unit 150) that displays information. Furthermore, the information processing apparatus 100 may be a device such as a smartphone, a tablet terminal, a laptop personal computer (PC), a desktop PC, a mobile phone, or a personal digital assistant (PDA), for example. In the example of FIG. 2, the information processing apparatus 100 is a laptop PC used by a user such as an operator who operates the mobile device 10.

Note that the information processing apparatus 100 may receive a user's operation by voice. The information processing apparatus 100 may include a sound sensor (microphone) that detects sound. In this case, the information processing apparatus 100 detects utterance of the user by the sound sensor. The information processing apparatus 100 may include software modules for processes such as voice signal processing, voice recognition, utterance semantic analysis, interaction control, and action output.

The information processing apparatus 100 is used to provide a service related to map creation. The information processing apparatus 100 performs various types of information processing related to map creation for the user. The information processing apparatus 100 is a computer that creates a preliminary map based on ranging information obtained by the optical ranging sensor 141, acquires measurement information obtained by the ultrasonic sensor 142, and extracts difference information between the preliminary map and the measurement information.

### 1-3. Configuration of Information Processing Apparatus According to Embodiment

Next, a configuration of an information processing apparatus 100 which is an example of an information processing apparatus that executes information processing according to an embodiment will be described. FIG. 4 is a diagram illustrating a configuration example of an information processing apparatus according to an embodiment.

As illustrated in FIG. 4, the information processing apparatus 100 includes a communication unit 110, a storage unit 120, a control unit 130, an input unit 140, and an output unit 150.

The communication unit 110 is actualized by a network interface card (NIC), for example. The communication unit 110 is connected to the network N (refer to FIG. 3) in a wired or wireless channel, and transmits/receives information to/from another information processing apparatus such as the mobile device 10. Furthermore, the communication unit 110 transmits/receives information to/from the mobile device 10.

The storage unit 120 is implemented by semiconductor memory elements such as random access memory (RAM) and flash memory, or other storage devices such as a hard disk or an optical disc. The storage unit 120 according to the embodiment includes an optical ranging sensor observation data storage unit 121, an ultrasonic sensor observation data storage unit 122, and a preliminary map information storage unit 123. The storage unit 120 and stores various types of information, in addition to the above. The storage unit 120 stores various types of information regarding an object such as an obstacle. The storage unit 120 may include an object information storage unit that stores various types of information regarding an object such as an obstacle.

The optical ranging sensor observation data storage unit 121 stores various types of information detected by the optical ranging sensor 141. The optical ranging sensor observation data storage unit 121 stores time-series data of information detected by the optical ranging sensor 141. The optical ranging sensor observation data storage unit 121 stores time-series data of the point cloud detected by the optical ranging sensor 141. The optical ranging sensor observation data storage unit 121 stores the point cloud data detected by the optical ranging sensor 141 and the detected time in association with each other.

The ultrasonic sensor observation data storage unit 122 stores various types of information detected by the ultrasonic sensor 142. The ultrasonic sensor observation data storage unit 122 stores time-series data of information detected by the ultrasonic sensor 142. The ultrasonic sensor observation data storage unit 122 stores information detected by the ultrasonic sensor 142 and a detected time in association with each other.

The preliminary map information storage unit 123 stores various types of information related to a map. The preliminary map information storage unit 123 stores a preliminary map based on information detected by the mobile device 10. For example, the preliminary map information storage unit 123 stores a two-dimensional preliminary map. For example, the preliminary map information storage unit 123 stores information such as the preliminary map PM11. For example, the preliminary map information storage unit 123 may store a three-dimensional preliminary map. For example, the preliminary map information storage unit 123 may store an occupancy grid map.

The control unit 130 is actualized by execution of programs stored in the information processing apparatus 100 (for example, information processing program according to the present disclosure, or the like) by a central processing unit (CPU), a micro processing unit (MPU), or the like, using RAM or the like, as a working area. In addition, the control unit 130 is a controller and is implemented by an integrated circuit such as an application specific integrated circuit (ASIC) or a field programmable gate array (FPGA).

As illustrated in FIG. 4, the control unit 130 includes an acquisition unit 131, a preliminary map generation unit 132, a transformation unit 133, a difference extraction unit 134, and a display unit 135, and implements or executes functions and operations of information processing described below. Not limited to the configuration illustrated in FIG. 4, the internal configuration of the control unit 130 may have a different configuration as long as it performs information processing described below. Furthermore, the connection relationship of the processing units included in the control unit 130 is not limited to the connection relationship illustrated in FIG. 4, and may be a different connection relationship.

The acquisition unit 131 acquires various types of information. The acquisition unit 131 acquires various types of information from an external information processing apparatus. The acquisition unit 131 acquires various types of information from the mobile device 10. The acquisition unit 131 acquires various types of information from another information processing apparatus such as a voice recognition server.

The acquisition unit 131 acquires various types of information from the storage unit 120. The acquisition unit 131 acquires various types of information from the optical ranging sensor observation data storage unit 121, the ultrasonic sensor observation data storage unit 122, and the preliminary map information storage unit 123.

The acquisition unit 131 acquires various types of information generated by the difference extraction unit 134. The acquisition unit 131 acquires various types of information generated by the difference extraction unit 134. The acquisition unit 131 acquires various types of information transformed by the transformation unit 133.

The acquisition unit 131 acquires measurement information obtained by the ultrasonic sensor 142. The acquisition unit 131 acquires measurement information obtained by the ultrasonic sensor 142 at the same time as creation of the preliminary map. The acquisition unit 131 acquires the measurement information detected by the ultrasonic sensor 142 at the timing when the ranging information is detected by the optical ranging sensor 141. The acquisition unit 131 acquires imaging information in which a position corresponding to the difference information is imaged by an imaging means. The acquisition unit 131 acquires imaging information obtained by the imaging means at the same time as creation of the preliminary map. The acquisition unit 131 acquires the imaging information obtained by the imaging means at the timing of detection of the ranging information by the optical ranging sensor 141.

The acquisition unit 131 receives various types of information. The acquisition unit 131 receives various types of information from an external information processing apparatus. The acquisition unit 131 receives various types of information from another information processing apparatus such as the mobile device 10. In the example of FIG. 2, the acquisition unit 131 receives the preliminary map PM11 from the mobile device 10. The acquisition unit 131 receives a result of self-position estimation of the mobile device 10 on the preliminary map. The acquisition unit 131 receives information indicating the self-position from the mobile device 10. The acquisition unit 131 receives the result of self-position estimation from the mobile device 10.

In the example of FIG. 1, the acquisition unit 131 acquires optical ranging sensor observation data DT1. The acquisition unit 131 acquires the optical ranging sensor observation data DT1 from the mobile device 10. The acquisition unit 131 acquires ultrasonic sensor observation data DT2. The acquisition unit 131 acquires the ultrasonic sensor observation data DT2 from the mobile device 10.

The preliminary map generation unit 132 performs various types of generation. The preliminary map generation unit 132 creates (generates) various types of information. The preliminary map generation unit 132 creates various types of information using various types of sensor information detected by the sensor unit 14. The preliminary map generation unit 132 acquires information from the storage unit 120 and generates various types of information based on the acquired information. The preliminary map generation unit 132 generates various types of information based on the information stored in the storage unit 120. The preliminary map generation unit 132 generates map information. The preliminary map generation unit 132 stores the generated information in the storage unit 120. The preliminary map generation unit 132 creates the preliminary map using various technologies related to map generation.

The preliminary map generation unit 132 creates the preliminary map based on the ranging information obtained by the optical ranging sensor 141. The preliminary map generation unit 132 updates the preliminary map. The preliminary map generation unit 132 updates the preliminary map based on the measurement information.

The preliminary map generation unit 132 updates the information regarding the position corresponding to the difference information in the preliminary map based on the measurement information. In a case where it is determined in the difference information that an obstacle is present based on the measurement information and it is determined by the ranging information that the obstacle is not present, the preliminary map generation unit 132 updates the preliminary map on an assumption that the obstacle is present. The preliminary map generation unit 132 updates the preliminary map on an assumption that an obstacle is present at a position of the preliminary map where it is determined by measurement information that an obstacle is present and where it is determined by ranging information that no obstacle is present. In a case where it is determined in the difference information that no obstacle is present based on the measurement information and it is determined by the ranging information that the obstacle is present, the preliminary map generation unit 132 updates the preliminary map on an assumption that the obstacle is not present. The preliminary map generation unit 132 updates the preliminary map on an assumption that no obstacle is present at a position of the preliminary map where it is determined by the measurement information that no obstacle is present and where it is determined by the ranging information that an obstacle is present.

When obstacle presence/absence information indicating presence or absence of another obstacle located within a predetermined range has been acquired from one obstacle, the preliminary map generation unit 132 updates the preliminary map based on the obstacle presence/absence information. When there is a first obstacle determined to be present by measurement information and when obstacle presence/absence information indicating the presence or absence of a second obstacle located within a predetermined range from the first obstacle has been acquired, the preliminary map generation unit 132 updates the preliminary map based on the obstacle presence/absence information. In a case where it is determined by the measurement information that the second obstacle is not present within the predetermined range from the first obstacle and it is determined by the ranging information that the second obstacle is present, the preliminary map generation unit 132 updates the preliminary map on an assumption that the second obstacle is not present.

The preliminary map generation unit 132 searches the preliminary map for a first location determined to have an obstacle by the measurement information of the difference information, and then searches the preliminary map for a second location determined to have an obstacle by the measurement information of the difference information. The preliminary map generation unit 132 updates the preliminary map for the first location determined to have an obstacle by the measurement information of the difference information, and then updates the preliminary map for the second location determined to have an obstacle by the measurement information of the difference information. The preliminary map generation unit 132 updates the preliminary map by arranging the preliminary obstacle at the first location determined to have an obstacle based on the measurement information, and subsequently, updates the preliminary map on an assumption that no obstacle is present by the measurement information and on an assumption that no obstacle is present at the second location determined to have an obstacle by the measurement information.

In the example of FIG. 2, the preliminary map generation unit 132 generates the preliminary map of the optical ranging sensor 141. The preliminary map generation unit 132 creates the preliminary map PM11 using point cloud information. For example, the preliminary map generation unit 132 generates the preliminary map PM11 using a map creation technology using a point cloud by LiDAR or the like.

Note that, in a case where the mobile device 10 generates the preliminary map, the preliminary map generation unit 132 may be included in the mobile device 10. In this case, the information processing apparatus 100 does not have to include the preliminary map generation unit 132. The information processing apparatus 100 may acquire (receive), from the mobile body 10, the preliminary map PM11 created and transmitted by the mobile body 10.

The transformation unit 133 transforms various types of information. The transformation unit 133 determines various types of information. The transformation unit 133 makes various decisions. For example, the transformation unit 133 determines various types of information based on information from an external information processing apparatus or information stored in the storage unit 120. The transformation unit 133 determines various types of information based on information from another information processing apparatus such as the mobile device 10. The transformation unit 133 determines various types of information based on information stored in the optical ranging sensor observation data storage unit 121, the ultrasonic sensor observation data storage unit 122, or the preliminary map information storage unit 123.

The transformation unit 133 determines various types of information based on the various types of information acquired by the acquisition unit 131. The transformation unit 133 determines various types of information based on the various types of information generated by the difference extraction unit 134. The transformation unit 133 makes various decisions based on the determination. The transformation unit 133 makes various decisions based on the information acquired by the acquisition unit 131.

The transformation unit 133 transforms the measurement information into the coordinate system of the preliminary map. The transformation unit 133 transforms a first coordinate system of the measurement information into a second coordinate system of the preliminary map.

In the example of FIG. 1, the transformation unit 133 transforms the ultrasonic sensor observation data DT2. The transformation unit 133 transforms the ultrasonic sensor observation data DT2. The transformation unit 133 transforms a coordinate system (coordinate system SX) corresponding to the measurement information detected by the ultrasonic sensor 142 into a coordinate system (coordinate system SY) of the optical ranging sensor 141. The transformation unit 133 performs a process of transforming the coordinate system SX of the ultrasonic sensor 142 into the coordinate system SY of the optical ranging sensor 141. The transformation unit 133 transforms the ultrasonic sensor observation data DT2 by appropriately using various known techniques related to coordinate transformation. The transformation unit 133 generates ultrasonic sensor transformation data which is data obtained by transforming the coordinate system of the ultrasonic sensor observation data DT2. The transformation unit 133 generates ultrasonic sensor transformation data obtained by transforming the coordinate system SX of the ultrasonic sensor observation data DT2 into the coordinate system SY.

The difference extraction unit 134 extracts various types of information. The difference extraction unit 134 generates various types of information. The difference extraction unit 134 extracts various types of information based on information from an external information processing apparatus and information stored in the storage unit 120. The difference extraction unit 134 extracts various types of information based on information from another information processing apparatus such as the mobile device 10. The difference extraction unit 134 extracts various types of information based on information stored in the optical ranging sensor observation data storage unit 121, the ultrasonic sensor observation data storage unit 122, or the preliminary map information storage unit 123.

The difference extraction unit 134 extracts various types of information based on the various types of information acquired by the acquisition unit 131. The difference extraction unit 134 extracts various types of information based on the various types of information transformed by the transformation unit 133.

The difference extraction unit 134 generates difference information based on the information transformed by the transformation unit 133. The difference extraction unit 134 extracts difference information between the preliminary map and the measurement information. The difference extraction unit 134 extracts difference information by using the measurement information transformed by the transformation unit 133.

In the example of FIG. 1, the difference extraction unit 134 extracts difference information between the optical ranging sensor preliminary map and the ultrasonic sensor transformation data. The difference extraction unit 134 extracts, as difference information, a position where no obstacle is present in the optical ranging sensor preliminary map and where an obstacle is present in the ultrasonic sensor transformation data. The difference extraction unit 134 extracts, as difference information, a position (region) corresponding to the measurement object OT1 in which no obstacle is observed in the optical ranging sensor preliminary map and in which an obstacle is observed in the ultrasonic sensor transformation data. The difference extraction unit 134 may extract difference information by using the preliminary map PM11 and the preliminary map PM12. The difference extraction unit 134 may compare the preliminary map PM11 with the preliminary map PM12 and extract different positions (regions) as difference information. The difference extraction unit 134 compares the preliminary map PM11 with the preliminary map PM12, and extracts a position (region) corresponding to the measurement object OT1 as difference information.

The display unit 135 displays various types of information. The display unit 135 displays various types of information by causing the output unit 150 to display various types of information. For example, the display unit 135 displays various types of information based on information from an external information processing apparatus or information stored in the storage unit 120. The display unit 135 displays various types of information based on information from another information processing apparatus such as the mobile device 10. The display unit 135 displays various types of information based on information stored in the optical ranging sensor observation data storage unit 121, the ultrasonic sensor observation data storage unit 122, or the preliminary map information storage unit 123.

The display unit 135 generates various types of information such as a screen (image information) to be displayed on the output unit 150 by appropriately using various technologies. The display unit 135 generates a screen (image information) and the like to be displayed on the output unit 150. For example, the display unit 135 generates a screen (image information) and the like to be displayed on the output unit 150 based on the information stored in the storage unit 120. In the example of FIG. 1, the display unit 135 generates content including a map screen, buttons BT1, BT2, and the like displayed on a tool screen TL of a tool X. The display unit 135 may generate a screen (image information) and the like by any process as long as it is possible to generate the screen (image information) or the like to be displayed on the output unit 150. For example, the display unit 135 generates a screen (image information) to be displayed on the output unit 150 by appropriately using various technologies related to image generation, image processing, and the like. For example, the display unit 135 generates a screen (image information) to be displayed on the output unit 150 by appropriately using various technologies such as Java (registered trademark). Note that the display unit 135 may generate a screen (image information) to be displayed on the output unit 150 based on a format such as CSS, JavaScript (registered trademark), or HTML. Furthermore, for example, the display unit 135 may generate a screen (image information) in various formats such as joint photographic experts group (JPEG), graphics interchange format (GIF), and portable network graphics (PNG).

The display unit 135 transmits various types of information to an external information processing apparatus, thereby presenting various types of information. The display unit 135 provides various types of information to an external information processing apparatus. The display unit 135 transmits various types of information to an external information processing apparatus. For example, the display unit 135 transmits various types of information to another information processing apparatus such as the mobile device 10. The display unit 135 provides the information stored in the storage unit 120. The display unit 135 transmits the information stored in the storage unit 120. The display unit 135 transmits, to the mobile device 10, an instruction to move the mobile device 10. The display unit 135 transmits an instruction to move the mobile device 10 to the mobile device 10 in accordance with a user's operation.

The display unit 135 provides various types of information based on information from another information processing apparatus such as the mobile device 10. The display unit 135 provides various types of information based on the information stored in the storage unit 120. The display unit 135 provides various types of information based on information stored in the optical ranging sensor observation data storage unit 121, the ultrasonic sensor observation data storage unit 122, or the preliminary map information storage unit 123.

The display unit 135 displays difference information. The display unit 135 displays a preliminary map. The display unit 135 displays the preliminary map by causing the output unit 150 to display the preliminary map.

In the example of FIG. 1, the display unit 135 displays the preliminary map PM11. The display unit 135 displays the preliminary map PM11 by causing the output unit 150 to display the preliminary map PM11. The display unit 135 displays the preliminary map PM12. The display unit 135 displays the preliminary map PM12 by causing the output unit 150 to display the preliminary map PM12. The display unit 135 displays the preliminary map PM12 including the measurement object OT1. The display unit 135 displays difference information. The display unit 135 displays the preliminary map PM12 including the information indicating the measurement object OT1 as the difference information.

Various operations are input from the user to the input unit 140. The input unit 140 receives various operations from a keyboard provided in the information processing apparatus 100 or a mouse connected to the information processing apparatus 100. The input unit 140 may have a keyboard or a mouse connected to the information processing apparatus 100. Furthermore, the input unit 140 may include a button provided in the information processing apparatus 100 or a microphone that detects a voice. The input unit 140 may have a function of detecting a voice.

For example, the input unit 140 may have a touch panel capable of actualizing functions equivalent to those of a keyboard and a mouse. In this case, various types of information are input to the input unit 140 via a display (output unit 150). The input unit 140 receives various operations from the user via a display screen by using a function of a touch panel actualized by various sensors. That is, the input unit 140 receives various operations from the user via the output unit 150 of the information processing apparatus 100. For example, the input unit 140 receives an operation such as a deletion operation or an obstacle arrangement operation by the user via the output unit 150 of the information processing apparatus 100. For example, the input unit 140 functions as a reception unit that receives a user's operation by the function of the touch panel. Here, the method of detecting the user's operation by the input unit 140 is implemented by mainly adopting a capacitance method in the tablet terminal. Alternatively, as long as the user's operation can be detected and the function of the touch panel can be implemented, it is allowable to adopt any method as a different type of detection method, such as a resistive film method, a surface acoustic wave method, an infrared method, and an electromagnetic induction method.

The output unit 150 is a display screen of a tablet device and the like actualized by, for example, a liquid crystal display, an organic electro-luminescence (EL) display, and the like, and is a display device for displaying various types of information.

### 1-4. Configuration of Mobile Device According to Embodiment

Next, a configuration of the mobile device 10, which is an example of a mobile body that executes information processing according to the embodiment, will be described. FIG. 5 is a diagram illustrating a configuration example of the mobile device 10 according to an embodiment.

As illustrated in FIG. 5, the mobile device 10 includes a communication unit 11, a storage unit 12, a control unit 13, the sensor unit 14, and a drive unit 15.

The communication unit 11 is implemented by, for example, an NIC, a communication circuit, or the like. The communication unit 11 is connected to a network N (the Internet, or the like) in a wired or wireless channel, and transmits/receives information to/from other devices or the like, via the network N.

The storage unit 12 is implemented by a semiconductor memory element such as RAM or flash memory, or a storage device such as a hard disk or an optical disk, for example. The storage unit 12 includes a preliminary map information storage unit 125.

The preliminary map information storage unit 125 stores various types of information related to a map. The preliminary map information storage unit 125 stores various types of information regarding the obstacle map. For example, the preliminary map information storage unit 125 stores a two-dimensional preliminary map. For example, the preliminary map information storage unit 125 stores information such as the preliminary map PM11. For example, the preliminary map information storage unit 125 may store a three-dimensional preliminary map. For example, the preliminary map information storage unit 125 may store an occupancy grid map.

Note that the storage unit 12 may store various types of information, not limited to information stored in the preliminary map information storage unit 125. In addition, the storage unit 12 stores position information of an object detected by the optical ranging sensor 141. For example, the storage unit 12 stores position information of an obstacle such as a wall. For example, the storage unit 12 may store position information and shape information of a reflecting object such as a mirror. For example, in a case where the information of the reflecting object has been acquired in advance, the storage unit 12 may store the position information and the shape information of the reflecting object and the like. For example, the storage unit 12 may detect a reflecting object using a camera and store position information and shape information of the detected reflecting object and the like.

Returning to FIG. 5, and description will continue. The control unit 13 is implemented by execution of programs stored in the mobile device 10 (for example, an information processing program according to the present disclosure) by the CPU, MPU, or the like, using RAM or the like as a working area. Furthermore, the control unit 13 may be implemented by an integrated circuit such as ASIC or FPGA.

As illustrated in FIG. 5, the control unit 13 includes a transmission/reception unit 136, a self-position estimation unit 137, and an execution unit 138, and implements or executes functions and operations of information processing described below. The internal configuration of the control unit 13 is not limited to the configuration illustrated in FIG. 5, and may be another configuration as long as it is a configuration that performs information processing described below.

The transmission/reception unit 136 executes transmission and reception of various types of information. The transmission/reception unit 136 receives various types of information. The transmission/reception unit 136 transmits various types of information. The transmission/reception unit 136 receives various types of information via the communication unit 11. The transmission/reception unit 136 transmits various types of information via the communication unit 11. The transmission/reception unit 136 receives various types of information from the information processing apparatus 100. The transmission/reception unit 136 transmits various types of information to the information processing apparatus 100. The transmission/reception unit 136 transmits information indicating the self-position estimated by the self-position estimation unit 137 to the information processing apparatus 100. The transmission/reception unit 136 transmits the sensor information detected by the sensor unit 14 to the information processing apparatus 100. The transmission/reception unit 136 transmits the sensor information detected by the optical ranging sensor 141 to the information processing apparatus 100. The transmission/reception unit 136 transmits the sensor information detected by the ultrasonic sensor 142 to the information processing apparatus 100.

The self-position estimation unit 137 performs various types of estimations. The self-position estimation unit 137 performs self-position estimation. The self-position estimation unit 137 generates information indicating the estimated self-position. The self-position estimation unit 137 acquires information from the storage unit 12 and performs various types of estimations based on the acquired information. The self-position estimation unit 137 performs various types of estimations using map information. The self-position estimation unit 137 performs self-position estimation using various techniques related to self-position estimation.

The self-position estimation unit 137 performs self-position estimation based on map information. The self-position estimation unit 137 performs self-position estimation based on the preliminary map.

In the example of FIG. 1, the self-position estimation unit 137 estimates the self-position using the point cloud information detected at the time of actual traveling and the preliminary map. The self-position estimation unit 137 calculates the self-position by matching the point cloud data such as LiDAR obtained during actual traveling with the preliminary map. The self-position estimation unit 137 detects the point cloud information while traveling in a place corresponding to the preliminary map PM11, and estimates the self-position by matching the detected point cloud information with the preliminary map.

The execution unit 138 executes various types of information. The execution unit 138 executes various processes based on information from an external information processing apparatus. The execution unit 138 executes various processes based on the information stored in the storage unit 12. The execution unit 138 executes various types of information based on the information stored in the preliminary map information storage unit 125. The execution unit 138 acquires information from the storage unit 12 and determines various types of information based on the acquired information.

The execution unit 138 executes various processes based on a preliminary map. The execution unit 138 executes various processes based on the self-position estimated by the self-position estimation unit 137. The execution unit 138 executes processes related to an action based on the self-position information generated by the self-position estimation unit 137. The execution unit 138 controls the drive unit 15 based on the self-position information generated by the self-position estimation unit 137 to execute an action corresponding to the self-position. The execution unit 138 executes the moving process of the mobile device 10 along the self-position under the control of the drive unit 15 based on the self-position information. The execution unit 138 executes the moving process of the mobile device 10 according to the self-position estimation based on the preliminary map performed by the self-position estimation unit 137. The execution unit 138 executes a moving process of the mobile device 10 in response to an instruction from the information processing apparatus 100.

The execution unit 138 performs various types of planning. The execution unit 138 generates various types of information related to action plans. The execution unit 138 performs various types of planning based on various types of information acquired from the storage unit 12, the information processing apparatus 100, and the like. The execution unit 138 performs various types of planning based on various types of information received by the transmission/reception unit 136. The execution unit 138 performs various types of planning based on the self-position estimated by the self-position estimation unit 137. The execution unit 138 performs an action plan using various techniques related to the action plan. Based on the information regarding the generated action plan, the execution unit 138 controls the drive unit 15 to execute an action corresponding to the action plan. Under the control of the drive unit 15 based on the information of the action plan, the execution unit 138 executes the moving process of the mobile device 10 in accordance with the action plan.

The sensor unit 14 detects predetermined information. The sensor unit 14 includes the optical ranging sensor 141 and the ultrasonic sensor 142.

The optical ranging sensor 141 is a ranging sensor using an optical system. For example, the optical ranging sensor 141 detects an electromagnetic wave (for example, light) having a frequency in a predetermined range. The optical ranging sensor 141, which is the electromagnetic wave optical ranging sensor 141, detects a distance between the measurement target and the optical ranging sensor 141. The optical ranging sensor 141 detects distance information between the measurement target and the optical ranging sensor 141. In the example of FIG. 1, the optical ranging sensor 141 is a LiDAR. The LiDAR detects a distance and a relative speed to a surrounding object by irradiating the surrounding object with a laser beam such as an infrared laser beam and measuring a time until the laser beam is reflected and returned. Furthermore, the optical ranging sensor 141 may be a ranging sensor using a millimeter wave radar. Note that the optical ranging sensor 141 is not limited to LiDAR, and may be various sensors such as a ToF sensor and a stereo camera.

The ultrasonic sensor 142 performs detection using ultrasonic waves. The ultrasonic sensor 142 is a sensor that measures a distance by ultrasonic waves. The ultrasonic sensor 142 detects a distance between the measurement target and the ultrasonic sensor 142. The ultrasonic sensor 142 detects distance information between the measurement target and the ultrasonic sensor 142. The ultrasonic sensor 142 transmits an ultrasonic wave and receives the ultrasonic wave reflected from the measurement target, thereby measuring the distance to the measurement target based on the time from transmission to reception.

Furthermore, the sensor unit 14 may include various other sensors, not limited to the optical ranging sensor 141 or the ultrasonic sensor 142. The sensor unit 14 may include a sensor as an imaging means of capturing an image. The sensor unit 14 has a function of an image sensor and detects image information. The sensor unit 14 may include a sensor (position sensor) that detects position information of the mobile device 10, such as a global positioning system (GPS) sensor. Note that the sensor unit 14 is not limited to the above, and may include various sensors. The sensor unit 14 may include various sensors such as an acceleration sensor and a gyro sensor. In addition, the sensor to detect the various types of information described above in the sensor unit 14 may be the same type of sensors or may be different types of sensors.

The drive unit 15 has a function of driving a physical configuration in the mobile device 10. The drive unit 15 has a function of moving the position of the mobile device 10. The drive unit 15 is, for example, an actuator. Note that the drive unit 15 may have any configuration as long as the mobile device 10 enables a desired operation. The drive unit 15 may have any configuration as long as enables the movement of the position of the mobile device 10 and the like. In a case where the mobile device 10 includes a moving mechanism such as a caterpillar or a tire, the drive unit 15 drives the caterpillar, the tire, or the like. For example, the drive unit 15 drives the moving mechanism of the mobile device 10 in accordance with an instruction from the execution unit 138 to move the mobile device 10 and change the position of the mobile device 10.

### 1-5. Procedure of Information Processing According to Embodiment

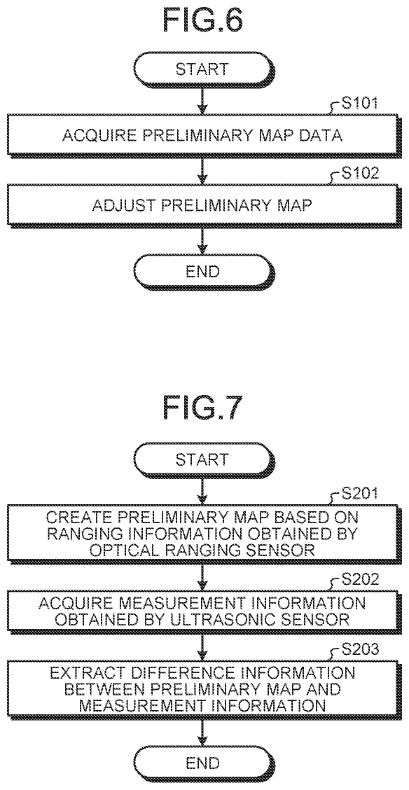

Next, an information processing procedure according to an embodiment will be described with reference to FIGS. 6 and 7. FIGS. 6 and 7 are flowcharts illustrating a procedure of information processing according to the embodiment. First, a flow of node arrangement processing according to the embodiment will be described with reference to FIG. 6. Specifically, FIG. 6 is a flowchart illustrating a procedure of adjusting a preliminary map. The process of each step in FIGS. 6 and 7 may be performed by any device included in the information processing system 1, such as the information processing apparatus 100 and the mobile device 10. The mobile device 10 includes the optical ranging sensor 141 and the ultrasonic sensor 142. The mobile device 10 only needs to include the optical ranging sensor 141 at the time of actual traveling using a preliminary map.

As illustrated in FIG. 6, the information processing system 1 acquires preliminary map data (step S101). For example, the information processing apparatus 100 acquires preliminary map data. For example, while acquiring data from the optical ranging sensor 141 and the ultrasonic sensor 142, the information processing system 1 causes the mobile device 10 (robot) to travel, for example, by the user manually pushing the mobile device 10, by the user operating the mobile device 10 with a remote controller, or by causing the mobile device 10 to travel by automatic search. While creating a preliminary map based on the point cloud data of the optical ranging sensor 141, the information processing system 1 transforms an observation result obtained by the ultrasonic sensor 142 into a coordinate system of the optical ranging sensor and holds the observation result.

The information processing system 1 adjusts the preliminary map (step S102). For example, the information processing apparatus 100 adjusts the preliminary map. The information processing system 1 displays, on a tool, the acquired preliminary map of the optical ranging sensor 141 and the acquired data of the ultrasonic sensor 142, and performs operations including elimination of a point cloud such as a mirror from the preliminary map or arrangement of a wall such as an acrylic plate or an inaccessible region while confirming the data on the tool by a person (user).

Next, a flow of processes up to extraction of difference information will be described with reference to FIG. 7. Specifically, FIG. 7 is a flowchart illustrating a procedure of extracting difference information.

As illustrated in FIG. 7, the information processing system 1 creates a preliminary map based on ranging information obtained by the optical ranging sensor 141 (step S201). For example, the information processing apparatus 100 creates a preliminary map based on ranging information obtained by the optical ranging sensor 141 of the mobile device 10. For example, the mobile device 10 creates a preliminary map based on ranging information obtained by the optical ranging sensor 141. The mobile device 10 creates a preliminary map by LiDAR or the like.

Subsequently, the information processing system 1 acquires the measurement information by the ultrasonic sensor 142 (step S202 of acquiring the measurement information by the ultrasonic sensor). For example, the information processing apparatus 100 acquires measurement information obtained by the ultrasonic sensor 142 of the mobile device 10.

Subsequently, the information processing system 1 extracts difference information between the preliminary map and the measurement information (step S202). For example, the information processing apparatus 100 extracts difference information between the preliminary map and the measurement information.

### 1-6. Procedure of Adjusting Map According to Embodiment

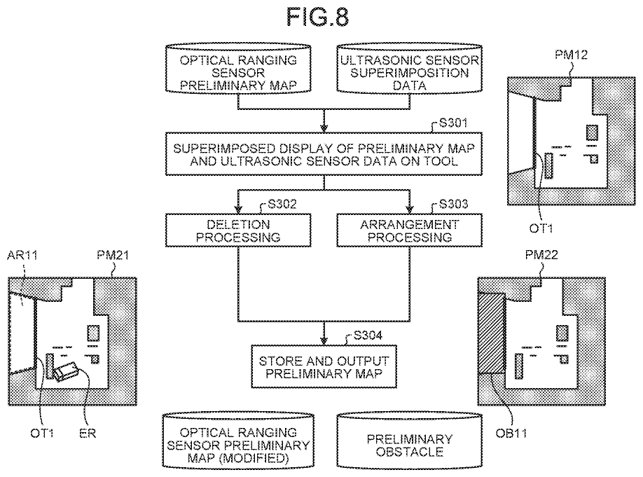

Next, a specific processing example of map adjustment will be described with reference to FIG. 8. FIG. 8 is a flowchart illustrating a map adjustment procedure according to the embodiment. In the example of FIG. 8, the information processing system 1 performs a superimposed display of the preliminary map and the ultrasonic sensor observation result on the tool, and adjusts the preliminary map.

As illustrated in FIG. 8, the information processing apparatus 100 performs a superimposed display of the preliminary map and the ultrasonic sensor data on the tool by using the optical ranging sensor preliminary map and the ultrasonic sensor superimposition data (step S301). The information processing apparatus 100 performs a superimposed display of the measurement object OT1 indicated by the ultrasonic sensor data on the preliminary map PM11. The information processing apparatus 100 displays the preliminary map PM12 in which the measurement object OT1 is superimposed on the preliminary map PM11. The information processing apparatus 100 performs a colored display of only a portion having a difference between the optical ranging sensor 141 and the ultrasonic sensor 142. The information processing apparatus 100 performs a colored display of the portion of the measurement object OT1. For example, the information processing apparatus 100 performs a colored display of the portion of the measurement object OT1 by appropriately using various techniques related to display of an image and the like.

Subsequently, the information processing apparatus 100 performs deletion processing according to the user's operation (step S302). For example, the information processing apparatus 100 performs deletion processing according to a user's operation using a deletion user interface (UI). For example, using a deletion tool ER as illustrated in a preliminary map PM21, the information processing apparatus 100 performs a deletion processing in response to a user's operation of deleting an object and the like located in a region AR11 on the back side of the measurement object OT1. In this manner, the user deletes total reflection objects such as mirrors or SUS plates from the preliminary map with reference to the ultrasonic sensor data. With this configuration, the information processing system 1 deletes total reflection objects from the matching target, thereby improving the self-position estimation performance in total reflection environments. Furthermore, the deletion UI may be a UI that deletes the point cloud data from the preliminary map by an eraser function like a paint application or that automatically deletes the point cloud data of the selected ultrasonic sensor data portion. For example, the eraser function may be a function of deleting the point cloud data of the region by adjusting the deletion tool ER to the region to be deleted.

Furthermore, the information processing apparatus 100 performs arrangement processing in accordance with a user's operation (step S303). For example, the information processing apparatus 100 performs the arrangement processing in accordance with the user's operation using the arrangement UI. For example, the information processing apparatus 100 performs arrangement processing according to an operation of arranging the obstacle OB11 in the measurement object OT1 and the region AR11 as illustrated in a preliminary map PM22 by the user using an arrangement tool. In this manner, the user arranges the transmissive object such as an acrylic plate or glass object as a preliminary obstacle with reference to the ultrasonic sensor data. Furthermore, the arrangement UI may be a UI that draws an obstacle like a paint application or automatically arranges an obstacle in a selected ultrasonic sensor data portion.

Note that step S302 and step S303 may be executed in parallel, or step S303 may be executed before step S302.

Subsequently, the information processing apparatus 100 stores and outputs the preliminary map (step S304). For example, the information processing apparatus 100 stores, in the preliminary map information storage unit 123, the preliminary map PM22 in which the obstacle OB11 is arranged at the position of the measurement object OT1 and the region AR11. The information processing apparatus 100 stores the preliminary map PM22 in the preliminary map information storage unit 123 as an optical ranging sensor preliminary map (modified). The information processing apparatus 100 updates the preliminary map to the preliminary map PM22. In addition, the information processing apparatus 100 stores preliminary obstacle information in the storage unit 120. In addition, the information processing apparatus 100 displays the preliminary map PM22 on the screen.

### 1-7. Movement and Detection of Mobile Body

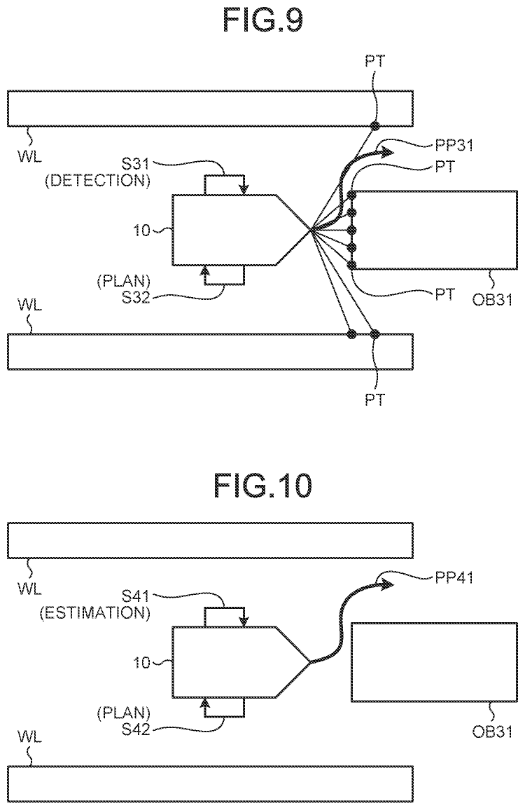

Here, movement and detection of the mobile body will be described with reference to FIGS. 9 to 12.

### 1-7-1. Movement of Mobile Body

First, movements of the mobile body will be described with reference to FIGS. 9 and 10. FIGS. 9 and 10 illustrate two examples of moving while avoiding an obstacle. The movement of the mobile body in response to the detection by the optical ranging sensor 141 will be described with reference to FIG. 9. FIG. 9 is a diagram illustrating an example of movement of a mobile device according to an embodiment. FIG. 9 illustrates a case where an obstacle OB31 is included in the preliminary map.

The mobile device 10 performs detection by the optical ranging sensor 141 (step S31). The mobile device 10 collects a point cloud (point cloud information) such as a plurality of points PT in FIG. 9 by detection using the optical ranging sensor 141. In the example of FIG. 9, the mobile device 10 detects the wall WL, the obstacle OB31, and the like positioned in the periphery by the optical ranging sensor 141. The mobile device 10 detects the obstacle OB31 located in the traveling direction.

Subsequently, the mobile device 10 performs an action plan according to the detection result obtained by the optical ranging sensor 141 (step S32). In the example of FIG. 9, the mobile device 10 plans a route PP31 diverted to the left side so as to avoid the obstacle OB31 located in the traveling direction. The mobile device 10 detects an obstacle on the spot and makes a plan so as not to collide with the obstacle. For example, the mobile device 10 makes a plan so as not to collide with an obstacle by calculating from a relative position from the own device.

In this manner, in the example of FIG. 9, the mobile device 10 recognizes an obstacle in real time by using the optical ranging sensor 141 during actual autonomous traveling, and stops or avoids the obstacle so as not to collide with the obstacle.

Next, movement of the mobile body according to the preliminary map will be described with reference to FIG. 10. FIG. 10 is a diagram illustrating an example of movement of a mobile device according to an embodiment. FIG. 10 illustrates a case where an obstacle OB41 is included in the preliminary map.

The mobile device 10 estimates a self-position (step S41). The mobile device 10 detects the point cloud information while traveling in a place corresponding to the preliminary map, and performs self-position estimation by matching the detected point cloud information with the preliminary map.

Subsequently, the mobile device 10 performs an action plan based on the estimated self-position and the preliminary map (step S42). In the example of FIG. 10, the mobile device 10 estimates that the obstacle OB41 is located in the traveling direction based on the estimated self-position and the preliminary map. The mobile device 10 plans a route PP41 diverted to the left side so as to avoid the obstacle OB41 located in the traveling direction. The mobile device 10 makes a plan so as not to collide with an obstacle by using the self-position calculated by self-position estimation and information regarding the obstacle embedded on the preliminary map.

In this manner, in the example of FIG. 10, the mobile device 10 embeds a wall or an inaccessible region on the map in advance, and stops or avoids the wall or the inaccessible region so as not to cause collision.

### 1-7-2. Detection by Optical Ranging Sensor

Next, detection by the optical ranging sensor will be described with reference to FIGS. 11 and 12. FIG. 11 is a diagram illustrating an example of detection by an optical ranging sensor according to an embodiment. FIG. 11 illustrates a case where a reflecting object MR is present around the mobile device 10. The reflecting object MR is an obstacle that reflects, with specular reflection, a detection target (electromagnetic wave) detected by the optical ranging sensor 141. For example, the reflecting object MR is a mirror, a stainless plate, or the like.

The mobile device 10 performs detection by the optical ranging sensor 141 (step S51). In the example of FIG. 11, the mobile device 10 detects a point PT corresponding to an obstacle OB51 by reflection by the reflecting object MR. With this configuration, the mobile device 10 detects a virtual image VI51 corresponding to the obstacle OB51 at a position in front of the reflecting object MR as an obstacle, without detecting the reflecting object MR.

Next, a case where a transparent object TB61 is present around the mobile device 10 will be described with reference to FIG. 12. FIG. 12 is a diagram illustrating an example of detection by an optical ranging sensor according to an embodiment. The transparent object TB61 is an obstacle that transmits a detection target (electromagnetic wave) to be detected by the optical ranging sensor 141. For example, the transparent object TB61 is glass, an acrylic plate, and the like.

The mobile device 10 performs detection by the optical ranging sensor 141 (step S61). In the example of FIG. 12, after transmission through the transparent object TB61, the mobile device 10 detects a point PT that corresponds to an obstacle OB61. With this configuration, the mobile device 10 detects the obstacle OB61 at a position in front of the transparent object TB61, without detecting the transparent object TB61.

### 1-8. Application Examples

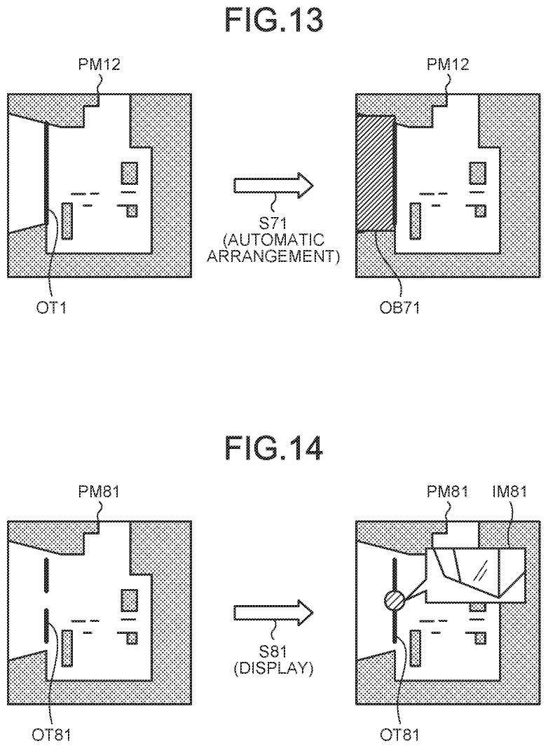

Next, application examples will be described with reference to FIGS. 13 and 14.

### 1-8-1. Automatic Arrangement

First, automatic arrangement of obstacles will be described with reference to FIG. 13. FIG. 13 is a diagram illustrating an example of map adjustment according to an embodiment.

In the example of FIG. 13, the information processing apparatus 100 performs a colored display of a portion having a difference between the optical ranging sensor 141 and the ultrasonic sensor 142. The information processing apparatus 100 performs a colored display of the portion of the measurement object OT1. Subsequently, the information processing apparatus 100 automatically arranges the obstacle on the preliminary map according to the observation result by the ultrasonic wave (step S71). The information processing apparatus 100 arranges a preliminary obstacle along a colored portion. In the example of FIG. 13, as illustrated in the preliminary map PM12, when the measurement object OT1 is observed by the ultrasonic sensor data, the information processing apparatus 100 automatically arranges an obstacle OB71 at a position corresponding to the measurement object OT1. For example, the information processing apparatus 100 automatically arranges the obstacle OB71 in the measurement object OT1 and a region on the back side of the measurement object OT1. For example, by appropriately using various techniques related to image processing and the like, the information processing apparatus 100 automatically arranges the obstacle OB71 in the measurement object OT1 and a region on the back side of the measurement object OT1. The information processing apparatus 100 determines an edge of the colored portion (measurement object OT1), and automatically aligns the position of the obstacle OB71 using a predetermined automatic adjustment function or the like so as to achieve arrangement.

### 1-8-2. Image Display

Next, display of an image will be described with reference to FIG. 14. FIG. 14 is a diagram illustrating an example of display according to the embodiment.

In the example of FIG. 14, even with a review of difference, there is a portion (a position corresponding to a measurement object OT81) in which whether there is an actually invisible wall is unknown. In such a case, the user often wants to confirm this portion on an actual site. The information processing apparatus 100 displays an image IM81 corresponding to the position where the measurement object OT81 is observed (step S81). The information processing apparatus 100 displays an image in accordance with a user's operation. In a case where the user performs an operation of designating the measurement object OT81, the information processing apparatus 100 performs a superimposed display of the image IM81 on a preliminary image PM81. For example, the mobile device 10 transmits an image captured by the image sensor to the information processing apparatus 100. The mobile device 10 transmits an image obtained by imaging, by an image sensor, a position where the measurement object OT81, being a point corresponding to the difference information, is observed by the image sensor at the same time as creation of the preliminary map PM81. For example, the mobile device 10 transmits an image captured by the image sensor to the information processing apparatus 100 in association with information of the imaging position and direction. For example, the mobile device 10 transmits an image to the information processing apparatus 100 in association with detection data obtained by the optical ranging sensor 141 or the ultrasonic sensor 142.

As described above, in the example of FIG. 14, the information processing system 1 captures an image with the image sensor on the mobile device 10 at the time of creating the preliminary image PM81. In this manner, by capturing and storing an image with the camera on the device at the time of creating the preliminary map, the information processing system 1 can confirm the scenery of the portion afterward. With this configuration, the information processing system 1 can allow the user to confirm, by the image, actual situation of the location where there is a difference in detections by the plurality of types of sensors.

### 1-9. Automatic Adjustment of Map

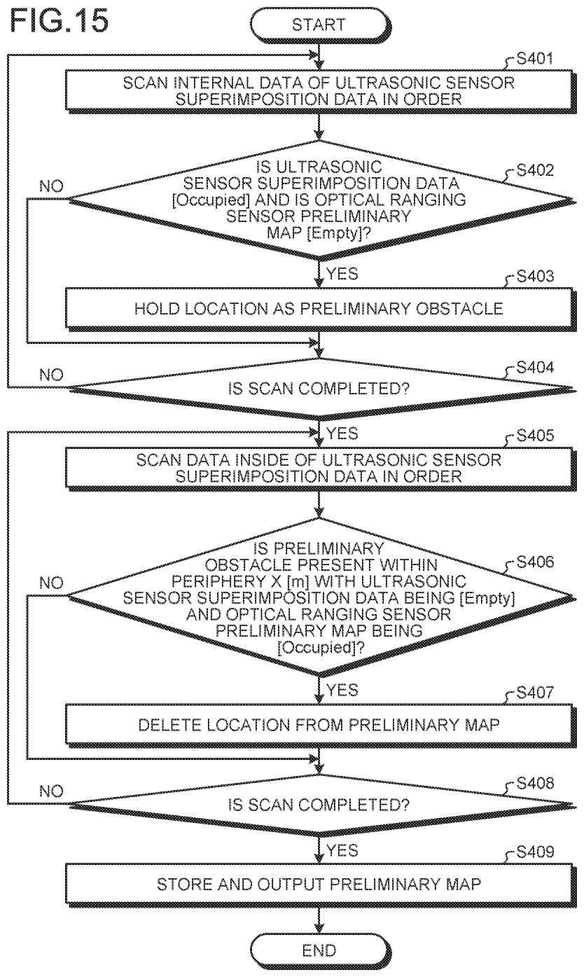

Adjustment of the map may be automatically performed without using user's operations. That is, automatic adjustment may be performed without human intervention. This point will be described with reference to FIG. 15. FIG. 15 is a diagram illustrating an example of automatic adjustment of a map. The process of FIG. 15 may be performed by any device included in the information processing system 1, such as the information processing apparatus 100 and the mobile device 10.

As illustrated in FIG. 15, the information processing system 1 sequentially scans internal data of the ultrasonic sensor superimposition data (step S401). For example, the information processing apparatus 100 sequentially scans data of ultrasonic sensor superimposition data.

In a case where the ultrasonic sensor superimposition data is [Occupied] and the optical ranging sensor preliminary map is [Empty] (step S402: Yes), the information processing system 1 holds the location as a preliminary obstacle (step S403). For example, in a case where there is an object in the ultrasonic sensor superimposition data and there is no object in the optical ranging sensor preliminary map, the information processing apparatus 100 holds the location as a preliminary obstacle. For example, in a case where the ultrasonic sensor 142 detects that there is an object and the optical ranging sensor 141 detects that there is no object, the information processing apparatus 100 holds the location as a preliminary obstacle.

In a case where the ultrasonic sensor superimposition data does not satisfy [Occupied] and the optical ranging sensor preliminary map does not satisfy [Empty] (step S402: No), the information processing system 1 performs the process of step S404 without performing the process of step S403.

In a case where the scan is not completed (step S404: No), the information processing system 1 returns to step S401 and repeats the process. For example, in a case where not all the scan of the ultrasonic sensor superimposition data has been completed, the information processing apparatus 100 returns to step S401 and repeats the process.

In contrast, when the scan is completed (step S404: Yes), the information processing system 1 performs the processes of step S405 and subsequent steps. For example, in a case where all the ultrasonic sensor superimposition data has been scanned, the information processing apparatus 100 performs the processes of step S405 and subsequent steps. Note that, in a case where the scan is completed, the information processing system 1 initializes information regarding the scan of the ultrasonic sensor superimposition data, and then performs the processes of step S405 and subsequent steps.

After the scan is completed (step S404: Yes), the information processing system 1 sequentially scans data inside the ultrasonic sensor superimposition data (step S405). For example, the information processing apparatus 100 sequentially scans data of ultrasonic sensor superimposition data.

In a case where the ultrasonic sensor superimposition data is [Empty], the optical ranging sensor preliminary map is [Occupied], and there is a preliminary obstacle within the periphery X [m] (step S406: Yes), the information processing system 1 deletes the location from the preliminary map (step S407). For example, in a case where there is no object in the ultrasonic sensor superimposition data, there is an object in the optical ranging sensor preliminary map, and there is a preliminary obstacle within the periphery X [m], the information processing apparatus 100 deletes the location from the preliminary map. For example, in a case where it is detected by the ultrasonic sensor 142 that an object is not present, it is detected by the optical ranging sensor 141 that an object is present, and there is a preliminary obstacle within the periphery X [m], the information processing apparatus 100 deletes the location from the preliminary map. Note that X is an arbitrary numerical value (for example, 1, 5, or the like), and is a value appropriately set according to a place where the mobile device 10 travels, a width of a route, and the like.

In a case where the ultrasonic sensor superimposition data is [Empty], the optical ranging sensor preliminary map is [Occupied], and where the condition that there is a preliminary obstacle within the periphery X [m] is not satisfied (step S406: No), the information processing system 1 performs the process of step S408 without performing the process of step S407.

In a case where the scan is not completed (step S408: No), the information processing system 1 returns to step S405 and repeats the process. For example, in a case where not all the scan of the ultrasonic sensor superimposition data has been completed, the information processing apparatus 100 returns to step S405 and repeats the process.

On the other hand, when the scan is completed (step S408: Yes), the information processing system 1 performs the processing of step S409. For example, in a case where all the ultrasonic sensor superimposition data has been scanned, the information processing apparatus 100 performs the process of step S409. When the scan is completed, the information processing system 1 initializes information regarding the scan of the ultrasonic sensor superimposition data.

After the scan is completed (step S408: Yes), the information processing system 1 stores and outputs the preliminary map (step S409). For example, the information processing apparatus 100 stores the preliminary map updated by the automatic adjustment in steps S401 to S408 in the preliminary map information storage unit 123. In addition, the information processing apparatus 100 displays the preliminary map updated by the automatic adjustment in steps S401 to S408 on the screen. With this configuration, for example, it is also possible to automatically adjust the preliminary map using the “optical ranging sensor preliminary map” and the “ultrasonic sensor superimposition data” on the actual device.

### 2. Other Embodiments

The process according to each of embodiments described above may be performed in various different forms (modifications) in addition to each of embodiments described above.

### 2-1. Other Configuration Examples

For example, although the above-described example is an exemplary case in which the information processing apparatus 100 that perform information processing and the mobile device 10 are separate from each other, the information processing apparatus and the mobile device may be integrated with each other. For example, the robot device and the tool may be integrated with each other. For example, a mobile device being a robot device and an information processing apparatus on which a tool is mounted (installed) may be integrated with each other. For example, the tool may be mounted (installed) on the robot device or may be mounted (installed) on the information processing apparatus.

### 2-2. Conceptual Diagram of Configuration of Information Processing System

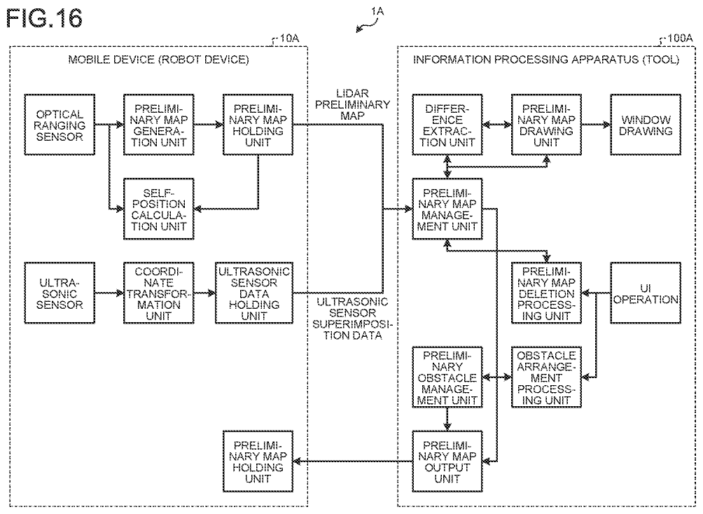

Furthermore, individual configurations included in the information processing apparatus 100 and the mobile device 10 may be included in any apparatus as long as the above-described processes can be implemented. For example, the function of generating the preliminary map included in the information processing apparatus 100 may be included in the mobile device 10. This point will be described with reference to FIG. 16. FIG. 16 conceptually illustrates individual functions, hardware configurations and data in an information processing apparatus 100A and a mobile device 10A of an information processing system 1A. FIG. 16 is a diagram illustrating an example of a conceptual diagram of a configuration of an information processing system according to a modification. Description of points similar to those of the information processing system 1 will be omitted. The information processing system 1A includes: the mobile device 10A having functions of preliminary map generation and coordinate transformation; and the information processing apparatus 100A. The mobile device 10A includes a preliminary map generation unit 132 and a transformation unit 133. In this case, the information processing apparatus 100A does not have to include the transformation unit 133.

The mobile device 10A being a robot device illustrated in FIG. 16 includes an optical ranging sensor, a preliminary map generation unit, a preliminary map holding unit, a self-position calculation unit, an ultrasonic sensor, a coordinate transformation unit, and an ultrasonic sensor data holding unit. For example, the optical ranging sensor corresponds to the optical ranging sensor 141. The preliminary map generation unit corresponds to the preliminary map creation unit 132. The preliminary map holding unit corresponds to the preliminary map information storage unit 125. The preliminary map stored in the preliminary map holding unit is transmitted to the tool. The self-position calculation unit corresponds to the self-position estimation unit 137. The ultrasonic sensor data holding unit corresponds to the storage unit 12. The mobile device 10A transmits a preliminary map such as a LiDAR preliminary map and ultrasonic sensor superimposition data to the information processing apparatus 100A.

The information processing apparatus 100A illustrated in FIG. 16 on which a tool is mounted includes a window drawing, a preliminary map drawing unit, a difference extraction unit, a preliminary map management unit, UI operation, a preliminary map deletion processing unit, an obstacle arrangement processing unit, a preliminary obstacle management unit, and a preliminary map output unit. The window drawing and the preliminary map drawing unit correspond to the display unit 135 and the output unit 150. The difference extraction unit corresponds to the difference extraction unit 134. The preliminary map management unit corresponds to the preliminary map information storage unit 123. The UI operation corresponds to the input unit 140. The preliminary map deletion processing unit corresponds to the preliminary map generation unit 132. The obstacle arrangement processing unit corresponds to the preliminary map generation unit 132. The preliminary obstacle management unit corresponds to an object information storage unit (not illustrated). The preliminary map output unit corresponds to the display unit 135. The preliminary map output unit transmits a preliminary map to the mobile device 10A.

### 2-3. Others

Furthermore, among each process described in the above embodiments, all or a part of the processes described as being performed automatically can be manually performed, or the processes described as being performed manually can be performed automatically by a known method. In addition, the processing procedures, specific names, and information including various data and parameters illustrated in the above specifications or drawings can be changed in any manner unless otherwise specified. For example, various types of information illustrated in each of the drawings are not limited to the information illustrated.

In addition, each of the components of each of the illustrated devices is provided as a functional and conceptional illustration and thus does not necessarily have to be physically configured as illustrated. That is, the specific form of distribution/integration of each of devices is not limited to those illustrated in the drawings, and all or a part thereof may be functionally or physically distributed or integrated into arbitrary units according to various loads and use conditions.

Furthermore, the above-described embodiments and modifications can be appropriately combined within a range implementable without contradiction of processes.

The effects described in the present specification are merely examples, and thus, there may be other effects, not limited to the exemplified effects.

### 3. Effects According to Present Disclosure

As described above, the information processing apparatus (the information processing apparatus 100 in the embodiment) according to the present disclosure includes: a preliminary map generation unit (the preliminary map generation unit 132 in the embodiment) that creates a preliminary map based on ranging information obtained by an optical ranging sensor (the optical ranging sensor 141 in the embodiment); an acquisition unit (the acquisition unit 131 in the embodiment) that acquires measurement information obtained by an ultrasonic sensor (the ultrasonic sensor 142 in the embodiment); and a difference extraction unit (the difference extraction unit 134 in the embodiment) that extracts difference information between the preliminary map and the measurement information.

With this configuration, the information processing apparatus according to the present disclosure extracts difference information between the preliminary map created based on the ranging information obtained by the optical ranging sensor and the measurement information obtained by the ultrasonic sensor, thereby enabling extraction of a difference in information detected by a plurality of types of sensors. Since the information processing apparatus can update the preliminary map based on the extracted difference, it is possible to create a more appropriate map integrating the detections by a plurality of types of sensors.

In addition, the acquisition unit acquires ranging information obtained by the ultrasonic sensor at the same time as the creation of the preliminary map. With this configuration, the information processing apparatus can extract difference information based on detection by the ultrasonic sensor at the same as the creation of the preliminary map, enabling extraction of differences in information detected by a plurality of types of sensors.

Furthermore, the information processing apparatus includes a transformation unit (the transformation unit 133 in the embodiment) that transforms the measurement information into the coordinate system of the preliminary map. The difference extraction unit extracts difference information by using the measurement information transformed by the transformation unit. With this configuration, the information processing apparatus can match the coordinate system of the measurement information by the ultrasonic sensor with the coordinate system of the preliminary map, making it possible to extract the difference information by matching the coordinate systems of the information detected by the plurality of types of sensors, enabling extraction of difference information with higher accuracy. Accordingly, the information processing apparatus can extract a difference in information detected by a plurality of types of sensors.

Furthermore, the information processing apparatus includes a display unit (the display unit 135 in the embodiment) that displays difference information. With this configuration, the information processing apparatus can allow the user to confirm the difference information, enabling update of the preliminary map based on the difference extracted after confirmation by the user.

In addition, the acquisition unit acquires imaging information obtained as a result of imaging a position corresponding to the difference information by an imaging means. With this configuration, the information processing apparatus can grasp the situation of the position corresponding to the difference information, making it possible to appropriately decide whether to update the preliminary map based on the extracted difference.

In addition, the acquisition unit acquires imaging information obtained by the imaging means at the same time as the creation of the preliminary map. With this configuration, the information processing apparatus can appropriately decide whether to update the preliminary map based on the imaging information obtained by the imaging means at the same time as the creation of the preliminary map.

In addition, the preliminary map generation unit updates the preliminary map. With this operation, the information processing apparatus can update the preliminary map based on the extracted difference, making it possible to create a more appropriate map integrating the detections by a plurality of types of sensors.

In addition, the preliminary map generation unit updates the preliminary map based on measurement information. With this configuration, by updating the preliminary map based on the measurement information, the information processing apparatus can create a more appropriate map integrating detections by a plurality of types of sensors.

In addition, the preliminary map generation unit updates the information regarding the position corresponding to the difference information in the preliminary map based on the measurement information. With this configuration, by updating the preliminary map for the information regarding the position corresponding to the difference information in the preliminary map, the information processing apparatus can create a more appropriate map integrating the detections by a plurality of types of sensors.

Moreover, in a case where it is determined in the difference information that an obstacle is present based on the measurement information and it is determined by the ranging information that the obstacle is not present, the preliminary map generation unit updates the preliminary map on the assumption that the obstacle is present. With this configuration, by updating the preliminary map for a location where presence or absence of an obstacle is different between sensors, the information processing apparatus can create a more appropriate map integrating the detections by a plurality of types of sensors.

In addition, in a case where it is determined in the difference information that no obstacle is present based on the measurement information and it is determined by the ranging information that the obstacle is present, the preliminary map generation unit updates the preliminary map on the assumption that the obstacle is not present. With this configuration, by updating the preliminary map for a location where presence or absence of an obstacle is different between sensors, the information processing apparatus can create a more appropriate map integrating the detections by a plurality of types of sensors.

In addition, when obstacle presence/absence information indicating presence or absence of another obstacle located within a predetermined range has been acquired from one obstacle, the preliminary map generation unit updates the preliminary map based on the obstacle presence/absence information. With this configuration, by updating the preliminary map based on the relationship of the determination result of the obstacle in the preliminary map, the information processing apparatus can create a more appropriate map integrating the detections by a plurality of types of sensors.

In addition, when there is a first obstacle determined to be present by measurement information and when obstacle presence/absence information indicating the presence or absence of a second obstacle located within a predetermined range from the first obstacle has been acquired, the preliminary map generation unit updates the preliminary map based on the obstacle presence/absence information. With this configuration, by updating the preliminary map based on the relationship between the obstacle whose presence has been detected by the optical ranging sensor in the preliminary map and the determination result of the obstacle within a predetermined range from the obstacle, the information processing apparatus can create a more appropriate map integrating the detections by a plurality of types of sensors.

Moreover, in a case where it is determined by the measurement information that the second obstacle is not present within a predetermined range from the first obstacle and it is determined by the ranging information that the second obstacle is present, the preliminary map generation unit updates the preliminary map on an assumption that the second obstacle is not present. With this configuration, by updating the preliminary map based on the detection result of the obstacle between the plurality of types of sensors, the information processing apparatus can create a more appropriate map integrating the detections of a plurality of types of sensors.

In addition, the preliminary map generation unit searches the preliminary map for a first location determined to have an obstacle by the measurement information of the difference information, and then searches the preliminary map for a second location determined to have an obstacle by the measurement information of the difference information. With this configuration, by updating the preliminary map based on the detection result of the obstacle between the plurality of types of sensors, the information processing apparatus can create a more appropriate map integrating the detections of a plurality of types of sensors.

Furthermore, the preliminary map generation unit updates the preliminary map by arranging a preliminary obstacle at a first location determined to have an obstacle based on the measurement information, and subsequently, updates the preliminary map on an assumption that no obstacle is present at a second location determined to have no obstacle by the measurement information and determined to have an obstacle by the measurement information. With this configuration, by updating the preliminary map based on the detection result of the obstacle between the plurality of types of sensors, the information processing apparatus can create a more appropriate map integrating the detections of a plurality of types of sensors.

### 4. Hardware Configuration

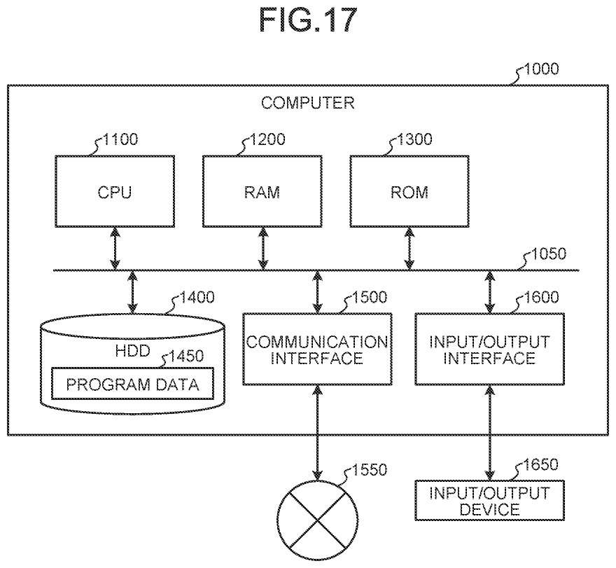

The information devices such as the information processing apparatus 100 and the mobile device 10 according to the above-described embodiment are implemented by a computer 1000 having a configuration as illustrated in FIG. 17, for example. FIG. 17 is a hardware configuration diagram illustrating an example of the computer 1000 that implements the functions of the information processing apparatus such as the information processing apparatus 100 and the mobile device 10. Hereinafter, the information processing apparatus 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops a program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory. For example, when the computer 1000 functions as the information processing apparatus 100 according to the embodiment, the CPU 1100 of the computer 1000 executes the information processing program loaded on the RAM 1200 so as to implement the functions of the control unit 13 and the like. Furthermore, the HDD 1400 stores the information processing program according to the present disclosure or data in the storage unit 12. While the CPU 1100 executes the program data 1450 read from the HDD 1400, the CPU 1100 may acquire these programs from another device via the external network 1550, as another example.

Note that the present technology can also have the following configurations.

(1)

An information processing apparatus comprising:

a preliminary map generation unit that creates a preliminary map based on ranging information obtained by an optical ranging sensor;

an acquisition unit that acquires measurement information obtained by an ultrasonic sensor; and

a difference extraction unit that extracts difference information between the preliminary map and the measurement information.

(2)

The information processing apparatus according to (1),

wherein the acquisition unit acquires the measurement information detected by the ultrasonic sensor at a same time as a time of creation of the preliminary map.

(3)

The information processing apparatus according to (1) or (2), further comprising

a transformation unit that transforms the measurement information into a coordinate system of the preliminary map,

wherein the difference extraction unit extracts the difference information by using the measurement information transformed by the transformation unit.

(4)

The information processing apparatus according to any one of (1) to (3), further comprising

a display unit that displays the difference information.

(5)

The information processing apparatus according to any one of (1) to (4),

wherein the acquisition unit acquires imaging information obtained by imaging a position corresponding to the difference information by an imaging means.

(6)

The information processing apparatus according to (5),

wherein the acquisition unit acquires the imaging information obtained by the imaging means at a same time as a time of creation of the preliminary map.

(7)

The information processing apparatus according to any one of (1) to (6),

wherein the preliminary map generation unit updates the preliminary map.

(8)

The information processing apparatus according to (7),

wherein the preliminary map generation unit updates the preliminary map based on the measurement information.

(9)

The information processing apparatus according to (7) or (8),

wherein the preliminary map generation unit updates information regarding a position corresponding to the difference information in the preliminary map, based on the measurement information.

(10)

The information processing apparatus according to any one of (7) to (9),

wherein, in a case where it is determined in the difference information that an obstacle is present by the measurement information and it is determined by the ranging information that the obstacle is not present, the preliminary map generation unit updates the preliminary map on an assumption that the obstacle is present.

(11)

The information processing apparatus according to any one of (7) to (10),

wherein, in a case where it is determined in the difference information that an obstacle is not present by the measurement information and it is determined by the ranging information that the obstacle is present, the preliminary map generation unit updates the preliminary map on an assumption that the obstacle is not present.

(12)

The information processing apparatus according to any one of (7) to (11),

wherein, when there is one obstacle and when obstacle presence/absence information indicating presence or absence of another obstacle located within a predetermined range from the one obstacle has been acquired, the preliminary map generation unit updates the preliminary map based on the obstacle presence/absence information.

(13)

The information processing apparatus according to any one of (7) to (12),

wherein, when there is a first obstacle determined to be present by the measurement information and when obstacle presence/absence information indicating presence or absence of a second obstacle located within a predetermined range from the first obstacle has been acquired, the preliminary map generation unit updates the preliminary map based on the obstacle presence/absence information.

(14)

The information processing apparatus according to (13),

wherein, when it is determined that the second obstacle is not present within a predetermined range from the first obstacle by the measurement information and it is determined that the second obstacle is present by the ranging information, the preliminary map generation unit updates the preliminary map on an assumption that the second obstacle is not present.

(15)

The information processing apparatus according to any one of (7) to (14),

wherein the preliminary map generation unit searches for a first location determined to have an obstacle by the measurement information of the difference information, and then searches for a second location determined to have an obstacle by the measurement information of the difference information.

(16)

The information processing apparatus according to any one of (7) to (15),

wherein the preliminary map generation unit updates the preliminary map by arranging a preliminary obstacle at a first location determined to have an obstacle based on the measurement information, and subsequently, updates the preliminary map on an assumption that no obstacle is present at a second location determined to have no obstacle by the measurement information and determined to have an obstacle by the measurement information.

(17)

An information processing method of executing processes comprising:

creating a preliminary map based on ranging information obtained by an optical ranging sensor;

acquiring measurement information obtained by an ultrasonic sensor; and

extracting difference information between the preliminary map and the measurement information.

(18)

An information processing program designed to execute processes comprising:

creating a preliminary map based on ranging information obtained by an optical ranging sensor;

acquiring measurement information obtained by an ultrasonic sensor; and

extracting difference information between the preliminary map and the measurement information.

### REFERENCE SIGNS LIST

100 INFORMATION PROCESSING APPARATUS
110 COMMUNICATION UNIT
120 STORAGE UNIT
121 OPTICAL RANGING SENSOR OBSERVATION DATA STORAGE UNIT
122 ULTRASONIC SENSOR OBSERVATION DATA STORAGE UNIT
123 PRELIMINARY MAP INFORMATION STORAGE UNIT
130 CONTROL UNIT
131 ACQUISITION UNIT
132 PRELIMINARY MAP GENERATION UNIT
133 TRANSFORMATION UNIT
134 DIFFERENCE EXTRACTION UNIT
135 DISPLAY UNIT
140 INPUT UNIT
150 OUTPUT UNIT
10 MOBILE DEVICE
11 COMMUNICATION UNIT
12 STORAGE UNIT
125 PRELIMINARY MAP INFORMATION STORAGE UNIT
13 CONTROL UNIT
136 TRANSMISSION/RECEPTION UNIT
137 SELF-POSITION ESTIMATION UNIT
138 EXECUTION UNIT
14 SENSOR UNIT
141 OPTICAL RANGING SENSOR
142 ULTRASONIC SENSOR
15 DRIVE UNIT

1. An information processing apparatus comprising:
a preliminary map generation unit that creates a preliminary map based on ranging information obtained by an optical ranging sensor;
an acquisition unit that acquires measurement information obtained by an ultrasonic sensor; and
a difference extraction unit that extracts difference information between the preliminary map and the measurement information.

2. The information processing apparatus according to claim 1,
wherein the acquisition unit acquires the measurement information detected by the ultrasonic sensor at a same time as a time of creation of the preliminary map.

3. The information processing apparatus according to claim 1, further comprising
a transformation unit that transforms the measurement information into a coordinate system of the preliminary map,
wherein the difference extraction unit extracts the difference information by using the measurement information transformed by the transformation unit.

4. The information processing apparatus according to claim 1, further comprising
a display unit that displays the difference information.

5. The information processing apparatus according to claim 1,
wherein the acquisition unit acquires imaging information obtained by imaging a position corresponding to the difference information by an imaging means.

6. The information processing apparatus according to claim 5,
wherein the acquisition unit acquires the imaging information obtained by the imaging means at a same time as a time of creation of the preliminary map.

7. The information processing apparatus according to claim 1,
wherein the preliminary map generation unit updates the preliminary map.

8. The information processing apparatus according to claim 7,
wherein the preliminary map generation unit updates the preliminary map based on the measurement information.

9. The information processing apparatus according to claim 7,
wherein the preliminary map generation unit updates information regarding a position corresponding to the difference information in the preliminary map, based on the measurement information.

10. The information processing apparatus according to claim 7,
wherein, in a case where it is determined in the difference information that an obstacle is present by the measurement information and it is determined by the ranging information that the obstacle is not present, the preliminary map generation unit updates the preliminary map on an assumption that the obstacle is present.

11. The information processing apparatus according to claim 7,
wherein, in a case where it is determined in the difference information that an obstacle is not present by the measurement information and it is determined by the ranging information that the obstacle is present, the preliminary map generation unit updates the preliminary map on an assumption that the obstacle is not present.

12. The information processing apparatus according to claim 7,
wherein, when there is one obstacle and when obstacle presence/absence information indicating presence or absence of another obstacle located within a predetermined range from the one obstacle has been acquired, the preliminary map generation unit updates the preliminary map based on the obstacle presence/absence information.

13. The information processing apparatus according to claim 7,
wherein, when there is a first obstacle determined to be present by the measurement information and when obstacle presence/absence information indicating presence or absence of a second obstacle located within a predetermined range from the first obstacle has been acquired, the preliminary map generation unit updates the preliminary map based on the obstacle presence/absence information.

14. The information processing apparatus according to claim 13,
wherein, when it is determined that the second obstacle is not present within a predetermined range from the first obstacle by the measurement information and it is determined that the second obstacle is present by the ranging information, the preliminary map generation unit updates the preliminary map on an assumption that the second obstacle is not present.

15. The information processing apparatus according to claim 7,
wherein the preliminary map generation unit searches for a first location determined to have an obstacle by the measurement information of the difference information, and then searches for a second location determined to have an obstacle by the measurement information of the difference information.

16. The information processing apparatus according to claim 7,
wherein the preliminary map generation unit updates the preliminary map by arranging a preliminary obstacle at a first location determined to have an obstacle based on the measurement information, and subsequently, updates the preliminary map on an assumption that no obstacle is present at a second location determined to have no obstacle by the measurement information and determined to have an obstacle by the measurement information.

17. An information processing method of executing processes comprising:
creating a preliminary map based on ranging information obtained by an optical ranging sensor;
acquiring measurement information obtained by an ultrasonic sensor; and
extracting difference information between the preliminary map and the measurement information.

18. An information processing program designed to execute processes comprising:
creating a preliminary map based on ranging information obtained by an optical ranging sensor;
acquiring measurement information obtained by an ultrasonic sensor; and
extracting difference information between the preliminary map and the measurement information.
